(19) United States
(12) Patent Application Publication
(10) Pub. No.: US 2026/0153883 A1
(43) Pub. Date: Jun. 4, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Yoonsup KIM, Suwon-si (KR); Boseok MOON, Suwon-si (KR)

(73) Assignee: SAMSUNG ELECTRONICS CO., LTD., Suwon-si (KR)

(21) Appl. No.: 19/414,693

(22) Filed: Dec. 10, 2025

Related U.S. Application Data
(63) Continuation of application No. PCT/KR2025/014687, filed on Sep. 19, 2025.

(30) Foreign Application Priority Data
Dec. 3, 2024 (KR) 10-2024-0177772

(51) Int. Cl. G05D 1/65; G05D 1/435; G05D 17/02; G05D 109/10

(52) U.S. Cl. CPC G05D 1/65; G05D 1/435; G05D 17/02; G05D 2109/14

(57) ABSTRACT

An electronic apparatus includes at least one sensor, memory storing instructions, and at least one processor, wherein the instructions, when executed, cause the apparatus to: identify, based on the apparatus moving, whether a first event for stopping the apparatus occurs; supply a first voltage for stopping the apparatus based on the first event being identified; acquire, through the at least one sensor, a speed related to movement of the apparatus and an inclination angle of a floor on which the apparatus travels; acquire, from the memory, a mass of the apparatus; acquire a stop torque for a stopping movement of the apparatus based on the speed, the inclination angle, and the mass; identify whether a second event occurs in which the stop torque is less than or equal to a critical torque; and supply a second voltage lower than the first voltage based on the second event being identified.

### CROSS-REFERENCE TO RELATED APPLICATION

This application is a bypass continuation of International Application No. PCT/KR2025/014687, filed on Sep. 19, 2025, which is based on and claims priority to Korean Patent Application No. 10-2024-0177772, filed on Dec. 3, 2024, in the Korean Intellectual Property Office, the disclosures of which are incorporated by reference herein in their entireties.

### BACKGROUND

### 1. Field

Apparatuses and methods consistent with the disclosure relate to an electronic apparatus and a controlling method thereof, and more particularly, to an electronic apparatus for controlling a supply voltage to stop movement of the electronic apparatus, and a controlling method thereof.

### 2. Description of Related Art

An electronic apparatus may perform a movement function. The electronic apparatus may generate a map related to traveling, or move to a specific location based on the generated map. A movement function of the electronic apparatus may include an acceleration function and a stop function. The acceleration function may represent a function for increasing speed. The stop function may be a function for decelerating current speed.

The electronic apparatus may perform a stop function for stopping according to a specific event. For example, in a situation where the electronic apparatus is a critical distance away from a target location, the electronic apparatus needs to reduce the current speed.

The electronic apparatus may perform the stop function to reduce the speed of the electronic apparatus. The electronic apparatus may supply a voltage for the stop function. The electronic apparatus may preset and supply a voltage for the stop function.

However, there is a problem in that power efficiency decreases when the voltage is supplied constantly.

### SUMMARY

The present disclosure relates to the above-described problem and provides an electronic apparatus that changes a magnitude of a supply voltage for stopping in consideration of stop torque, and a controlling method thereof.

According to an aspect of the disclosure, an electronic apparatus includes at least one sensor; memory storing instructions; and at least one processor, wherein the instructions, when executed by the at least one processor, individually or collectively, cause the electronic apparatus to identify, based on the electronic apparatus moving, whether a first event for stopping the electronic apparatus occurs, supply a first voltage for stopping the electronic apparatus based on the first event being identified, acquire, through the at least one sensor, a speed related to movement of the electronic apparatus and an inclination angle of a floor on which the electronic apparatus travels, acquire, from data stored in the memory, a mass of the electronic apparatus, acquire a stop torque for a stopping movement of the electronic apparatus based on the speed, the inclination angle, and the mass, identify whether a second event occurs in which the stop torque is less than or equal to a critical torque, and supply a second voltage lower than the first voltage based on the second event being identified.

The at least one sensor may include an inertial sensor, and the instructions, when executed by the at least one processor, individually or collectively, may cause the electronic apparatus to acquire the speed and the inclination angle based on sensing data received from the inertial sensor.

The electronic apparatus may further include a motor, and the first voltage and the second voltage may be supplied to the motor to stop the electronic apparatus by changing a current direction of the motor to an opposite direction.

The instructions, when executed by the at least one processor, individually or collectively, may cause the electronic apparatus to acquire, from data stored in the memory, a wheel radius, gravitational acceleration, and a stop time of the electronic apparatus, and acquire the stop torque based on at least one of the speed, the inclination angle, the mass, the wheel radius, the gravitational acceleration, or the stop time.

The instructions, when executed by the at least one processor, individually or collectively, may cause the electronic apparatus to acquire a motion torque based on at least one of the mass, the speed, the wheel radius, or the stop time, acquire a load torque related to gravity and frictional force acting on the electronic apparatus, and acquire the stop torque based on the motion torque and the load torque.

The instructions, when executed by the at least one processor, individually or collectively, may cause the electronic apparatus to acquire a gravitational torque related to the gravity based on at least one of the mass, the gravitational acceleration, the inclination angle, or the wheel radius, acquire a friction torque related to the frictional force based on at least one of a coefficient of friction, the mass, the gravitational acceleration, the inclination angle, or the wheel radius, and acquire the load torque based on the gravitational torque and the friction torque.

The instructions, when executed by the at least one processor, individually or collectively, may cause the electronic apparatus to acquire a linear speed of a wheel of the electronic apparatus, and acquire the coefficient of friction based on the speed related to the movement of the electronic apparatus and the linear speed of the wheel.

The instructions, when executed by the at least one processor, individually or collectively, may cause the electronic apparatus to identify, based on the second voltage being supplied, whether a third event occurs in which the electronic apparatus is in a stop state, acquire the inclination angle through the at least one sensor at a time point at which the third event is identified, and supply a third voltage less than the second voltage based on the inclination angle being less than a critical angle.

The instructions, when executed by the at least one processor, individually or collectively, may cause the electronic apparatus to supply a fourth voltage higher than the second voltage based on the inclination angle being greater than or equal to the critical angle.

The instructions, when executed by the at least one processor, individually or collectively, may cause the electronic apparatus to identify whether a fourth event for power cutoff occurs, and stop supplying the third voltage or the fourth voltage based on the fourth event being identified.

According to an aspect of the disclosure, a controlling method of an electronic apparatus includes identifying, based on the electronic apparatus moving, whether a first event for stopping the electronic apparatus occurs; supplying a first voltage for stopping the electronic apparatus based on the first event being identified; acquiring, through at least one sensor of the electronic apparatus, a speed related to movement of the electronic apparatus and an inclination angle of a floor on which the electronic apparatus travels; acquiring, from data stored in memory of the electronic apparatus, a mass of the electronic apparatus; acquiring a stop torque for stopping movement of the electronic apparatus based on the speed, the inclination angle, and the mass; identifying whether a second event occurs in which the stop torque is less than or equal to a critical torque; and supplying a second voltage lower than the first voltage based on the second event being identified.

The acquiring of the speed and the inclination angle may include acquiring the speed and the inclination angle based on sensing data received from an inertial sensor of the electronic apparatus.

The first voltage and the second voltage may be supplied to a motor of the electronic apparatus to stop the electronic apparatus by changing a current direction of the motor to an opposite direction.

The acquiring the stop torque may include acquiring, from data stored in the memory of the electronic apparatus, a wheel radius, gravitational acceleration, and a stop time of the electronic apparatus; and acquiring the stop torque based on at least one of the speed, the inclination angle, the mass, the wheel radius, the gravitational acceleration, or the stop time.

The acquiring the stop torque may include acquiring a motion torque based on at least one of the mass, the speed, the wheel radius, or the stop time; acquiring a load torque related to gravity and frictional force acting on the electronic apparatus; and acquiring the stop torque based on the motion torque and the load torque.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram for describing an operation of moving and stopping an electronic apparatus according to an embodiment.

FIG. 2 is a block diagram illustrating the electronic apparatus according to an embodiment.

FIG. 3 is a block diagram for describing a configuration of the electronic apparatus of FIG. 2 according to an embodiment.

FIG. 4 is a diagram for describing a stop torque calculation module according to an embodiment.

FIG. 5 is a diagram for describing the stop torque calculation module according to an embodiment.

FIG. 6 is a diagram for describing a driving voltage control module according to an embodiment.

FIG. 7 is a diagram for describing an operation of controlling a voltage according to multiple events according to an embodiment.

FIG. 8 is a diagram for describing an operation of changing a voltage using stop torque according to an embodiment.

FIG. 9 is a diagram for describing an operation of calculating stop torque according to an embodiment.

FIG. 10 is a diagram for describing the operation of calculating stop torque according to an embodiment.

FIG. 11 is a diagram for describing the operation of calculating stop torque according to an embodiment.

FIG. 12 is a diagram for describing the operation of calculating stop torque according to an embodiment.

FIG. 13 is a diagram for describing an operation of calculating a coefficient of friction according to an embodiment.

FIG. 14 is a diagram for describing the operation of calculating stop torque according to an embodiment.

FIG. 15 is a diagram for describing an operation of controlling a magnitude of voltage using an inclination angle according to an embodiment.

FIG. 16 is a diagram for describing an operation of controlling a voltage on an uphill road according to an embodiment.

FIG. 17 is a diagram for describing an operation of controlling a voltage on a flat road according to an embodiment.

FIG. 18 is a diagram for describing an operation of controlling a voltage on a downhill road according to an embodiment.

FIG. 19 is a diagram for describing the operation of controlling a voltage on an uphill road according to an embodiment.

FIG. 20 is a diagram for describing the operation of controlling a voltage on a flat road according to an embodiment.

FIG. 21 is a diagram for describing the operation of controlling a voltage on a downhill road according to an embodiment.

FIG. 22 is a diagram for describing the operation of controlling a voltage on an uphill road according to an embodiment.

FIG. 23 is a diagram for describing the operation of controlling a voltage on a flat road according to an embodiment.

FIG. 24 is a diagram for describing the operation of controlling a voltage on a downhill road according to an embodiment.

FIG. 25 is a diagram for describing power efficiency according to an embodiment.

FIG. 26 is a diagram for describing a controlling method of an electronic apparatus according to an embodiment.

### DETAILED DESCRIPTION

Hereinafter, embodiments are described in detail with reference to the accompanying drawings. The embodiments described in the disclosure, and the configurations shown in the drawings, are only examples of embodiments, and various modifications may be made without departing from the scope and spirit of the disclosure.

General terms that are currently widely used were selected as terms used in embodiments of the present disclosure in consideration of functions in the present disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the present disclosure. Therefore, the terms used in the present disclosure should be defined on the basis of the meaning of the terms and the contents throughout the present disclosure rather than simple names of the terms.

In the present disclosure, an expression “have”, “may have”, “include”, “may include”, or the like, indicates existence of a corresponding feature (for example, a numerical value, a function, an operation, a component such as a part, or the like), and does not exclude existence of an additional feature.

An expression “at least one of A and/or B” is to be understood to represent “A” or “B” or “any one of A and B.”

Expressions “first”, “second”, or the like, used in the present disclosure may indicate various components regardless of a sequence and/or importance of the components, will be used only in order to distinguish one component from the other components, and do not limit the corresponding components.

When it is mentioned that any component (for example: a first component) is (operatively or communicatively) coupled with/to or is connected to another component (for example: a second component), it is to be understood that any component is directly coupled to another component or may be coupled to another component through the other component (for example: a third component).

Singular expressions are intended to include plural expressions unless the context clearly indicates otherwise. It will be further understood that the terms “comprises” or “have” used in this specification, specify the presence of stated features, steps, operations, components, parts mentioned in this specification, or a combination thereof, but do not preclude the presence or addition of one or more other features, numerals, steps, operations, components, parts, or a combination thereof.

In the disclosure, a “module” or a “˜er/or” may perform at least one function or operation, and be implemented by hardware or software or be implemented by a combination of hardware and software. In addition, a plurality of “modules” or a plurality of “˜ers/ors” may be integrated in at least one module and be implemented by at least one processor except for a ‘module’ or an ‘˜er/or’ that needs to be implemented by specific hardware.

In the disclosure, the term user may refer to a person using an electronic apparatus or a device (for example, an artificial intelligence electronic apparatus) using an electronic apparatus.

Hereinafter, an embodiment of the disclosure will be described in detail with reference to the accompanying drawings.

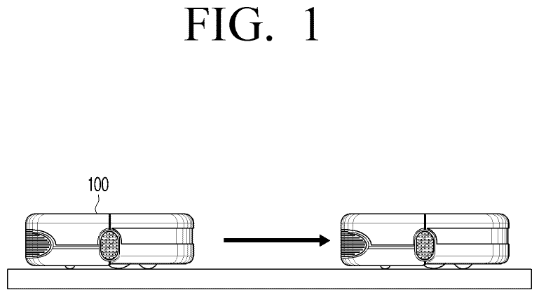

FIG. 1 is a diagram for describing an operation of moving and stopping an electronic apparatus 100 according to an embodiment.

The electronic apparatus 100 may mean a mobile electronic apparatus or an electronic apparatus for controlling a mobile device. For example, the electronic apparatus 100 may mean an electronic apparatus capable of driving or a device for controlling an electronic apparatus. The electronic apparatus 100 may include a movable member. The electronic apparatus 100 may control a motor to rotate the movable member. A location of the electronic apparatus 100 may move according to a rotation of the movable member.

As an example, the electronic apparatus 100 may be a mobile cleaning robot that performs a cleaning operation.

As an example, the electronic apparatus 100 may be a mobile service robot that provides various services to a user.

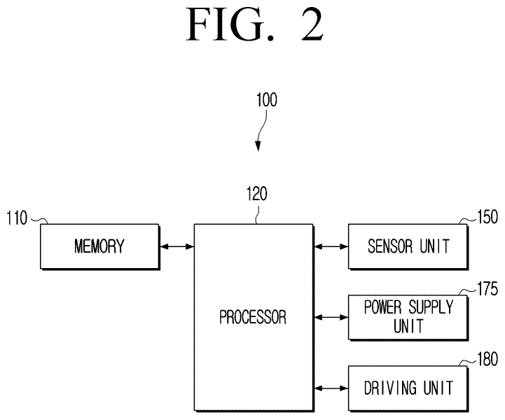

FIG. 2 is a block diagram illustrating the electronic apparatus 100 according to an embodiment.

Referring to FIG. 2, the electronic apparatus 100 may include a sensor unit 150 (at least one sensor), a memory 110 storing instructions, and at least one processor 120 including processing circuitry.

At least one processor 120 may identify, based on the electronic apparatus 100 moving, whether a first event for stopping the electronic apparatus 100 occurs.

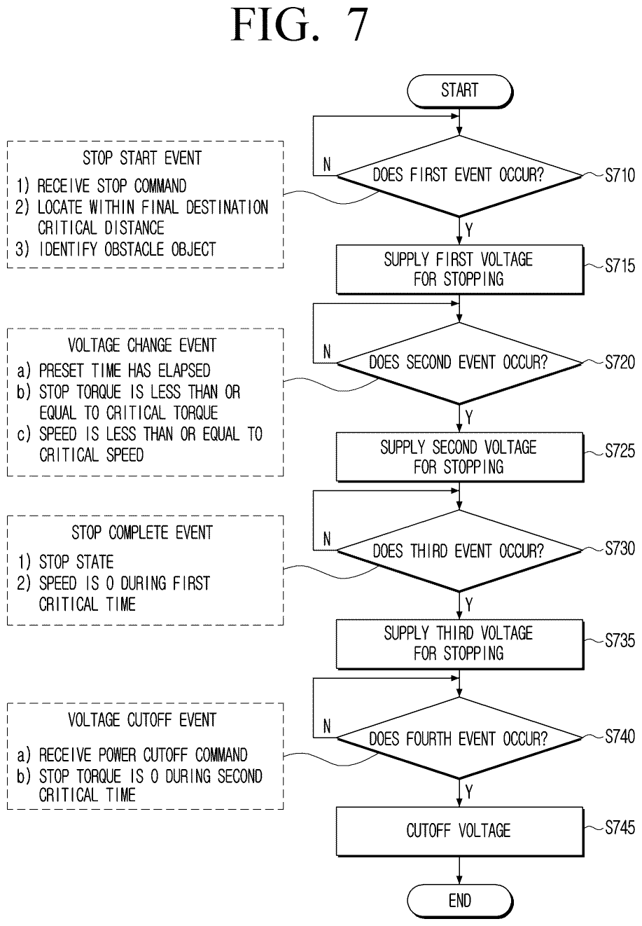

The first event may include at least one of an event for receiving a stop command, an event for being located within a critical distance from a final destination, or an event for identifying an obstacle object. A description related to the first event is described with reference to FIG. 7.

When the first event is identified, at least one processor 120 may supply a first voltage for stopping the electronic apparatus 100.

The first voltage may be a stop voltage. The first voltage may be a voltage for transmitting force in a direction opposite to a current rotation direction of the motor.

At least one processor 120 may calculate the first voltage in various ways.

For example, the first voltage may be a preset value.

For example, the first voltage may be determined based on at least one of a mass of the electronic apparatus 100, a speed of the electronic apparatus 100, and an inclination angle of the electronic apparatus 100. At least one processor 120 may determine the first voltage based on at least one of the mass, the speed, or the inclination angle.

For example, the greater the mass, the higher the first voltage may be.

For example, the faster the speed, the higher the first voltage may be.

For example, the greater the inclination angle, the higher the first voltage may be.

At least one processor 120 may acquire the speed of the electronic apparatus 100 and the inclination angle of the electronic apparatus 100 through the sensor unit 150.

The sensor unit 150 may include an inertial sensor 151. At least one processor 120 may acquire the speed related to the movement of the electronic apparatus 100 and the inclination angle of a floor on which the electronic apparatus 100 travels based on sensing data received from the inertial sensor 151.

For example, after the first event is identified, at least one processor 120 may receive the sensing data from the inertial sensor 151.

For example, regardless of the identification of the first event, at least one processor 120 may acquire the sensing data from the inertial sensor 151 in real time.

At least one processor 120 may acquire the mass of the electronic apparatus 100 from data stored in the memory 110.

At least one processor 120 may acquire a stop torque for stopping the movement of the electronic apparatus 100 based on the speed, the inclination angle, and the mass. The stop torque may represent torque for applying force in a direction opposite to the current moving direction of the electronic apparatus 100. The stop torque may represent force applied in an opposite direction to a direction in which the wheel of the electronic apparatus 100 rotates. The stop torque may represent torque that should be provided to the electronic apparatus 100 to stop the electronic apparatus 100.

At least one processor 120 may identify whether a second event occurs in which the stop torque is less than or equal to a critical torque. The second event may include at least one of an event in which a preset time has elapsed from the time point at which the first voltage is supplied, an event in which the stop torque is less than or equal to the critical torque, or an event in which the speed is less than or equal to a critical speed. The second event is described with reference to FIG. 7.

When the second event is identified, at least one processor 120 may supply a second voltage that is lower than the first voltage. The first voltage may be a voltage for initial stopping, and the second voltage may be a voltage that is supplied after a predetermined time has elapsed. In order to reduce the initial deceleration speed and then slowly reduce the speed, a magnitude of the second voltage may be lower than the first voltage.

The electronic apparatus 100 may include a driving unit 180.

The electronic apparatus 100 may include a motor. The motor may be included in the driving unit 180.

The electronic apparatus 100 may include a power supply unit 175. The power supply unit 175 may supply a driving voltage for rotating the motor. At least one processor 120 may control the power supply unit 175 to determine a supply voltage (for example, the first voltage or the second voltage) and transmit (or supply) the determined supply voltage to the motor. The voltage supplied in a situation where the electronic apparatus 100 accelerates may be described as an acceleration voltage. The voltage supplied in the situation where the electronic apparatus 100 stops may be described as a stop voltage.

The first voltage and the second voltage may be voltages supplied to the motor to stop the electronic apparatus 100 by changing a current direction of the motor to the opposite direction.

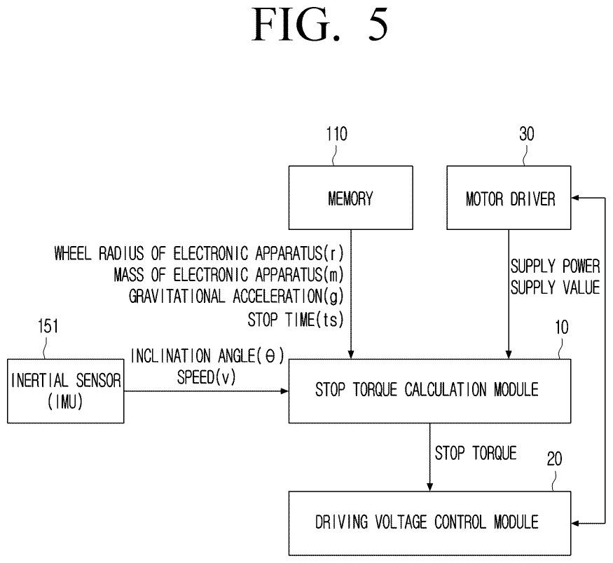

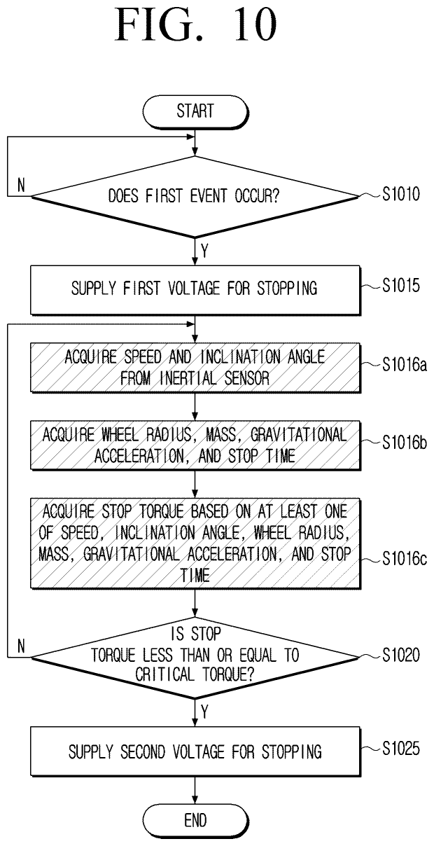

At least one processor 120 may acquire a wheel radius, a gravitational acceleration, and a stop time of the electronic apparatus 100 from data stored in the memory 110. At least one processor 120 may acquire the stop torque based on at least one of the speed, the inclination angle, the mass, the wheel radius, the gravitational acceleration, or the stop time. A description related thereto will be described with reference to FIGS. 5 and 10.

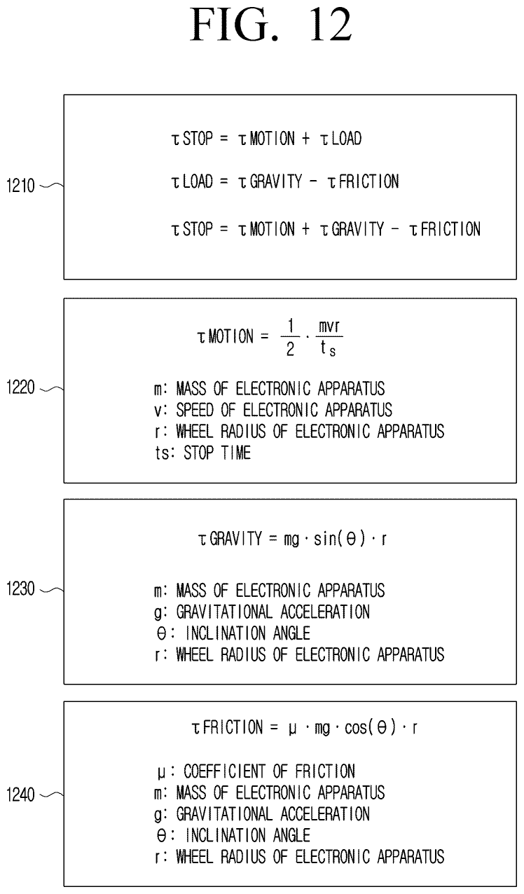

At least one processor 120 may acquire motion torque based on at least one of the mass, the speed, the wheel radius, or the stop time. A description related thereto will be described in an embodiment 1220 of FIG. 12.

At least one processor 120 may acquire the load torque related to gravity and frictional force acting on the electronic apparatus 100. At least one processor 120 may acquire the stop torque based on the motion torque and the load torque. A description related thereto will be described in the embodiment 1210 of FIG. 12.

At least one processor 120 may acquire the stop torque by adding up the load torque and the motion torque.

At least one processor 120 may acquire gravitational torque related to gravity based on at least one of the mass, the gravitational acceleration, the inclination angle, or the wheel radius. A description related thereto will be described in an embodiment 1230 of FIG. 12.

At least one processor 120 may acquire the friction torque related to friction based on at least one of the coefficient of friction, the mass, the gravitational acceleration, the inclination angle, or the wheel radius. A description related thereto will be described in an embodiment 1240 of FIG. 12.

At least one processor 120 may acquire the load torque based on the gravitational torque and the friction torque. At least one processor 120 may acquire the load torque by subtracting the friction torque from the gravitational torque. A description related thereto will be described in the embodiment 1210 of FIG. 12.

At least one processor 120 may acquire the coefficient of friction in various ways.

For example, the coefficient of friction may be a preset value. The coefficient of friction may be changed according to a user's setting.

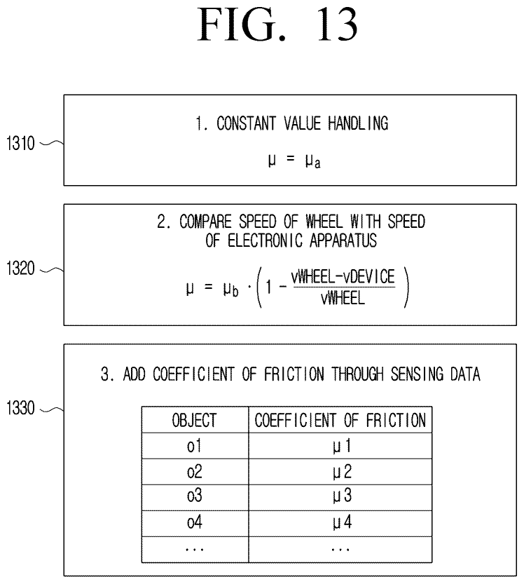

For example, the coefficient of friction may be determined based on a slip coefficient. At least one processor 120 may acquire a linear speed of the wheel of the electronic apparatus 100. At least one processor 120 may acquire the coefficient of friction based on the linear speed of the wheel and the speed of the electronic apparatus 100. A description related thereto will be described in an embodiment 1320 of FIG. 13.

For example, the coefficient of friction may be determined based on an object identified in the sensing data. At least one processor 120 may acquire image data through a camera. At least one processor 120 may identify the coefficient of friction through the object included in the image data. At least one processor 120 may acquire LIDAR data acquired through a LIDAR sensor. At least one processor 120 may identify the coefficient of friction through the object included in the LIDAR data. A description related thereto will be described in an embodiment 1330 of FIG. 13.

At least one processor 120 may identify whether a third event occurs when the electronic apparatus 100 is in a stop state after supplying the second voltage. The third event may include at least one of an event in which the electronic apparatus 100 is in the stop state or an event in which the speed is 0 during a first critical time. A description related thereto will be described with reference to FIG. 7.

When the third event is identified, at least one processor 120 may acquire the inclination angle through the sensor unit 150 at the time point at which the third event is identified.

When the inclination angle is less than the critical angle, at least one processor 120 may supply a third voltage lower than the second voltage.

When the inclination angle is greater than or equal to the critical angle, at least one processor 120 may supply a fourth voltage larger than the second voltage.

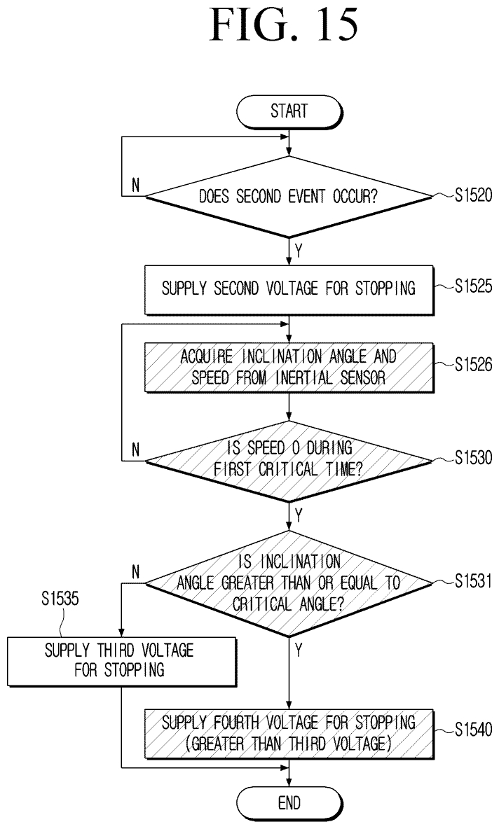

A description related thereto will be described with reference to FIG. 15.

At least one processor 120 may identify whether a fourth event for power cutoff occurs. When the fourth event is identified, at least one processor 120 may stop supplying the third voltage or the fourth voltage. The fourth event may include at least one of an event of receiving a power cutoff command or an event in which the stop torque is 0 during a second critical time. Power consumption may be reduced by cutting off the power supply. A description related thereto will be described with reference to FIG. 7.

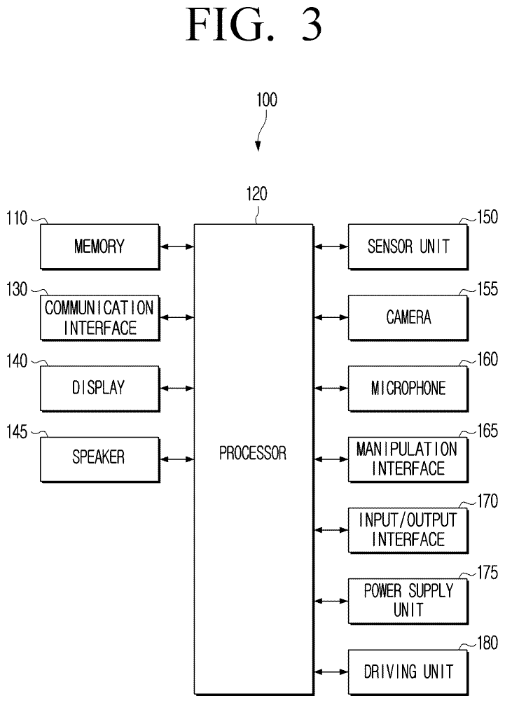

FIG. 3 is a block diagram for explaining a configuration of the electronic apparatus 100 of FIG. 2 according to an embodiment.

Referring to FIG. 3, the electronic apparatus 100 may include at least one of the memory 110, at least one processor 120, a communication interface 130, a display 140, a speaker 145, a sensor unit 150, a camera 155, a microphone 160, a manipulation interface 165, an input/output interface 170, the power supply unit 175, and the driving unit 180.

The memory 110 may be implemented by an internal memory such as a read-only memory (ROM) (for example, an electrically erasable programmable read-only memory (EEPROM)), a random access memory (RAM), or the like, included in at least one processor 120 or be implemented by a memory separate from at least one processor 120. In this case, the memory 110 may be implemented in a form of a memory embedded in the electronic apparatus 100 or a form of a memory attachable to and detachable from the electronic apparatus 100, depending on a data storing purpose. For example, data for driving the electronic apparatus 100 may be stored in the memory embedded in the electronic apparatus 100, and data for an extension function of the electronic apparatus 100 may be stored in the memory attachable to and detachable from the electronic apparatus 100.

The memory embedded in the electronic apparatus 100 may be implemented by at least one of a volatile memory (for example, a dynamic RAM (DRAM), a static RAM (SRAM), a synchronous dynamic RAM (SDRAM), or the like) or a non-volatile memory (for example, a one time programmable ROM (OTPROM), a programmable ROM (PROM), an erasable and programmable ROM (EPROM), an electrically erasable and programmable ROM (EEPROM), a mask ROM, a flash ROM, a flash memory (for example, a NAND flash, a NOR flash, or the like), a hard drive, or a solid state drive (SSD)), and the memory attachable to and detachable from the electronic apparatus 100 may be implemented in a form such as a memory card (for example, a compact flash (CF), a secure digital (SD), a micro-SD, a mini-SD, an extreme digital (xD), a multi-media card (MMC), or the like), an external memory (for example, a universal serial bus (USB) memory) connectable to a USB port, or the like.

The memory 110 may store at least one instruction. At least one processor 120 may perform various operations based on an instruction stored in the memory 110.

At least one processor 120 may perform an overall control operation of the electronic apparatus 100. At least one processor 120 may perform an overall operation of the electronic apparatus 100.

At least one processor 120 may be implemented by a digital signal processor (DSP), a microprocessor, or a time controller (TCON) that processes a digital signal. However, the processor 120 is not limited thereto, but may include one or more of a central processing unit (CPU), a micro controller unit (MCU), a micro processing unit (MPU), a controller, an application processor (AP), a graphics-processing unit (GPU), a communication processor (CP), and an advanced reduced instruction set computer (RISC) machines (ARM) processor, or may be defined by these terms. At least one processor 120 may be implemented by a system-on-chip (SoC) or a large scale integration (LSI) in which a processing algorithm is embedded, or may be implemented in a field programmable gate array (FPGA) form. At least one processor 120 may perform various functions by executing computer executable instructions stored in the memory.

The communication interface 130 is a component performing communication with various types of external apparatuses depending on various types of communication manners. The communication interface 130 may include a wireless communication module or a wired communication module. Each communication module may be implemented in the form of at least one hardware chip.

The wireless communication module may be a module that wirelessly communicates with an external device. For example, the wireless communication module may include at least one of a Wi-Fi module, a Bluetooth module, an infrared communication module, or other communication modules.

The Wi-Fi module and the Bluetooth module may perform communication in the Wi-Fi method and the Bluetooth method, respectively. In the case of using the Wi-Fi module or the Bluetooth module, various connection information such as a service set identifier (SSID), a session key, and the like, is first transmitted and received, communication is connected using the connection information, and various information may then be transmitted and received.

The infrared communication module performs communication according to an infrared data association (IrDA) technology of wirelessly transmitting data to a short distance using an infrared ray positioned between a visible ray and a millimeter wave.

Other wireless communication modules may include at least one communication chip performing communication according to various wireless communication standards such as ZigBee, 3^{rd} generation (3G), 3^{rd} generation partnership project (3GPP), long term evolution (LTE), LTE advanced (LTE-A), 4^{th} generation (4G), 5^{th} generation (5G), and the like, in addition to the communication manner described above.

The wired communication module may be a module that communicates with an external device in a wired manner. For example, the wired communication module may include at least one of a local area network (LAN) module, an Ethernet module, a pair cable, a coaxial cable, an optical fiber cable, or an ultra wide-band (UWB) module.

According to an embodiment, the communication interface 130 may use the same communication module (for example, the WiFi module) to communicate with an external device such as a remote control and an external server.

According to an example, the communication interface 130 may use different communication modules to communicate with an external device such as a remote control and an external server. For example, the communication interface 130 may use at least one of the Ethernet module or the WiFi module to communicate with the external server, and may use a Bluetooth module to communicate with the external device such as the remote control. However, this is only an example, and the communication interface 130 may use at least one of various communication modules in a case in which it communicates with a plurality of external devices or external servers.

The display 140 may be implemented by various types of displays such as a liquid crystal display (LCD), an organic light emitting diode (OLED) display, a plasma display panel (PDP), and the like. A driving circuit, a backlight unit, and the like, that may be implemented in a form such as an amorphous silicon thin film transistor (a-si TFT), a low temperature poly silicon (LTPS) TFT, an organic TFT (OTFT), and the like, may be included in the display 140. The display 140 may be implemented as a touch screen coupled with a touch sensor, a flexible display, a three-dimensional display (3D display), etc. According to an embodiment of the present disclosure, the display 140 may include not only a display panel that outputs an image, but also a bezel that houses the display panel. In particular, according to an embodiment of the present disclosure, the bezel may include a touch sensor for detecting user interaction.

The speaker 145 may be a component that outputs not only various audio data but also various notification sounds, voice messages, etc.

The sensor unit 150 may collect data indicating a state related to the surrounding environment or the electronic apparatus 100. The sensor unit 150 may include at least one sensor. The sensor unit 150 may include a sensor that senses the external environment of the electronic apparatus 100. The sensor unit 150 may include a sensor that senses the internal state of the electronic apparatus 100. The sensing data collected through the sensor may be transmitted to one of the memory 110, at least one processor 120, and the communication interface 130 of the electronic apparatus 100.

The camera 155 is configured to generate a captured image by capturing a subject, in which the captured image is a concept including both a moving image and a still image. The camera 155 may acquire an image of at least one external device, and may be implemented as a camera, a lens, an infrared sensor, or the like.

The camera 155 may include a lens and an image sensor. A type of lens includes a general or multi-purpose lens, a wide-angle lens, a zoom lens, and the like, and may be determined according to the type, characteristic, use environment, and the like of the electronic apparatus 100. As the image sensor, a complementary metal oxide semiconductor (CMOS), a charge coupled device (CCD), and the like may be used.

The microphone 160 is a component for receiving a user′ voice or other sounds and converting the user's voice or other sounds into audio data. The microphone 160 may receive the user's voice in an activated state. For example, the microphone 160 may be formed integrally on an upper side or in a front direction, a side direction, etc., of the electronic apparatus 100. The microphone 160 may include various configurations such as a microphone that collects user voices in analog form, an amplifier circuit that amplifies the collected user voices, an A/D conversion circuit that samples the amplified user voices and converts the amplified user voices into digital signals, and a filter circuit that removes noise components from the converted digital signals.

The manipulation interface 165 may be implemented as a device such as a button, a touch pad, a mouse, and a keyboard, or may be implemented as a touch screen capable of performing the above-described display function and manipulation input function together. The button may be various types of buttons such as a mechanical button, a touch pad, a wheel, and the like, formed in any region such as a front surface portion, a side surface portion, a rear surface portion, and the like, of a body appearance of the electronic apparatus 100.

The input/output interface 170 may be an interface of any one of a high definition multimedia interface (HDMI), a mobile high-definition link (MHL), a universal serial bus (USB), a display port (DP), Thunderbolt, a video graphics array (VGA) port, an RGB port, a D-subminiature (D-SUB), and a digital visual interface (DVI). The input/output interface 170 may input/output at least one of audio and video signals. According to the implementation example, the input/output interface 170 may include a port for inputting/outputting only an audio signal and a port for inputting/outputting only a video signal as separate ports, or may be implemented as a single port for inputting/outputting both an audio signal and a video signal. The electronic apparatus 100 may transmit at least one of audio and video signals to an external device (e.g., an external display device or an external speaker) through the input/output interface 170. An output port included in the input/output interface 170 may be connected to an external device, and the electronic apparatus 100 may transmit at least one of the audio and video signals to the external device through the output port.

The input/output interface 170 may be connected to a communication interface. The input/output interface 170 may transmit information received from an external device to the communication interface, or transmit information received through the communication interface to an external device.

The power supply unit 175 may generate, convert, or supply power to the electronic apparatus 100. The power supply unit 175 may generate a supply voltage or a supply current using power. The power generated by the power supply unit 175 may be supplied to various components included in the electronic apparatus 100.

The driving unit 180 may be a component that generates and transmits a physical force that controls the traveling of the electronic apparatus 100. The driving unit 180 may include a motor.

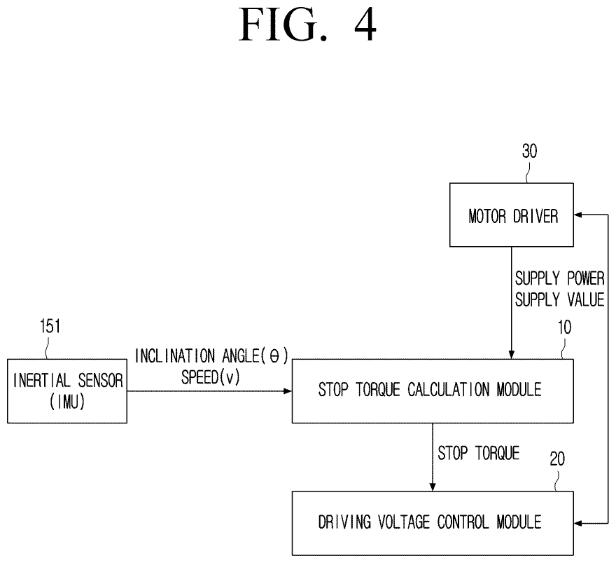

FIG. 4 is a diagram for describing a stop torque calculation module 10 according to an embodiment.

Referring to FIG. 4, the electronic apparatus 100 may include at least one of the stop torque calculation module 10, a driving voltage control module 20, a motor driver 30, and an inertial sensor 151.

When the stop torque calculation module 10, the driving voltage control module 20, and the motor driver 30 are implemented as software, the stop torque calculation module 10, the driving voltage control module 20, and the motor driver 30 may be stored in the memory 110.

When the stop torque calculation module 10, the driving voltage control module 20, and the motor driver 30 are implemented as hardware, the stop torque calculation module 10, the driving voltage control module 20, and the motor driver 30 may be included in at least one processor 120.

The inertial sensor 151 may be included in the sensor unit 150. The inertial sensor 151 may represent a sensor that measures inertia. The inertial sensor 151 may include an inertial measurement unit (IMU) sensor. The inertial sensor 151 may include at least one of a speed sensor, an acceleration sensor, a gyro sensor, and a tilt sensor.

The inertial sensor 151 may acquire the sensing data including the inclination angle of the electronic apparatus 100 through the tilt sensor. The inertial sensor 151 may acquire the sensing data including the speed of the electronic apparatus 100 through the speed sensor.

The inertial sensor 151 may transmit at least one of the inclination angle or the speed to the stop torque calculation module 10.

The motor driver 30 may control the motor included in the driving unit 180. The motor driver 30 may supply power supplied from the power supply unit 175 to the motor. The motor driver 30 may control whether the supply power is supplied, the magnitude of the supply power, etc.

The motor driver 30 may acquire a supply power value indicating the magnitude of the supply power (supply voltage or supply current). The motor driver 30 may transmit the supply power value to the stop torque calculation module 10.

The stop torque calculation module 10 may receive at least one of the inclination angle or the speed from the inertial sensor 151. The stop torque calculation module 10 may receive the supply power value from the motor driver 30.

The stop torque calculation module 10 may calculate the load torque using the supply power value received from the motor driver 30. The stop torque calculation module 10 may calculate the stop torque based on at least one of the load torque, the inclination angle, and the speed.

The stop torque calculation module 10 may be a module that calculates the stop torque. The stop torque calculation module 10 may output the stop torque based on a preset algorithm or a preset mathematical formula.

The driving voltage control module 20 may be a module that controls the driving voltage based on the stop torque. The driving voltage control module 20 may receive the stop torque from the stop torque calculation module 10. The driving voltage control module 20 may determine the driving voltage for controlling the motor based on the stop torque.

The driving voltage control module 20 may control the motor driver 30 based on the driving voltage. As a result, the motor driver 30 may control the motor using the driving voltage. The moving speed of the electronic apparatus 100 may be accelerated or decelerated under the control of the motor.

In FIG. 4, the process of calculating the load torque based on the supply power value by the stop torque calculation module 10 is described. The process of calculating the load torque using a value other than the supply voltage value will be described with reference to FIG. 5.

FIG. 5 is a diagram for describing the stop torque calculation module 10 according to an embodiment.

The stop torque calculation module 10, the driving voltage control module 20, the motor driver 30, and the inertial sensor 151 of FIG. 5 may correspond to the description of FIG. 4. The memory 110 of FIG. 5 may correspond to the memory 110 of FIG. 3 Accordingly, for additional implementation details, reference may be made to the descriptions of FIG. 3.

The stop torque calculation module 10 may receive at least one of the inclination angle or the speed from the inertial sensor 151.

The stop torque calculation module 10 may receive at least one of the wheel radius of the electronic apparatus 100, the mass of the electronic apparatus 100, the gravitational acceleration, or the stop time from the memory 110.

The stop torque calculation module 10 may calculate the stop torque based on at least one of the inclination angle, the speed, the wheel radius of the electronic apparatus 100, the mass of the electronic apparatus 100, the gravitational acceleration, or the stop time.

The stop torque calculation module 10 may transmit the stop torque to the driving voltage control module 20. The driving voltage control module 20 may determine the driving voltage for controlling the motor based on the stop torque. The driving voltage control module 20 may control the motor using the motor driver 30. The moving speed of the electronic apparatus 100 may be accelerated or decelerated under the control of the motor.

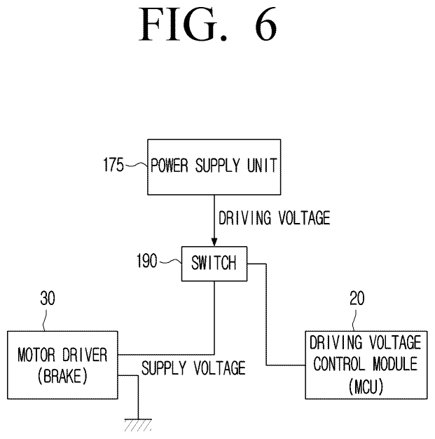

FIG. 6 is a diagram for describing a driving voltage control module according to an embodiment.

Referring to FIG. 6, the electronic apparatus 100 may include at least one of the power supply unit 175, the driving voltage control module 20, the motor driver 30, and a switch 195.

The electronic apparatus 100 may implement a brake system based on at least one of the power supply unit 175, the driving voltage control module 20, the motor driver 30, and the switch 195.

The power supply unit 175 may supply a driving voltage.

The driving voltage control module 20 may convert the driving voltage. The driving voltage control module 20 may change (or convert) the magnitude of voltage based on the determined stop torque. The brake system may be controlled to transmit the changed driving voltage to the motor driver 30. As an example, the driving voltage control module 20 may include a microcontroller unit (MCU).

The motor driver 30 may perform a brake function to decelerate the moving speed using the changed driving voltage. The motor driver 30 may generate a torque opposite to a current rotation direction of the motor by reversing a direction of current flowing in the motor.

The switch 190 may control a switching element so that the driving voltage or the changed driving voltage of the power supply unit 175 is transmitted (switch on) or not transmitted (switch off) to the motor driver 30. The on or off of the switch 190 may be determined by the driving voltage control module 20.

For example, the switch 190 may change the driving voltage supplied from the power supply unit 175 to the supply voltage. The switch 190 may represent a voltage conversion module that performs a switching function. The voltage conversion method may be determined by the driving voltage control module 20.

The driving voltage control module 20 may control the switch 190 by controlling a pulse width modulation (PWM) duty. The electronic apparatus 100 may control the switch 190 to transmit the driving voltage of the power supply unit 175 to the motor driver 30.

For example, the brake system may be a plugging system.

For example, the brake system may be a dynamic braking system.

For example, the brake system may be a regenerative braking system.

FIG. 7 is a diagram for describing an operation of controlling a voltage according to multiple events according to an embodiment.

Referring to FIG. 7, the electronic apparatus 100 may identify whether the first event has occurred.

The first event may include at least one of an event for receiving a stop command, an event for being located within a critical distance from a final destination, or an event for identifying an obstacle object.

As an example, the stop command may be received by a user. The electronic apparatus 100 may receive a user input for stopping the movement of the electronic apparatus 100.

As an example, the stop command may be acquired based on a preset instruction. The preset instruction may represent an instruction that is automatically executed.

As an example, the electronic apparatus 100 may drive in a designated space. When a location in the space is set as a final destination, the electronic apparatus 100 may stop within a critical distance from the final destination.

For example, the electronic apparatus 100 may identify an obstacle object around the electronic apparatus 100 based on the sensing data (LIDAR sensing data or image data). When the obstacle object is identified, the electronic apparatus 100 may stop.

When the first event is identified (S710-Y), the electronic apparatus 100 may supply the first voltage for stopping (S715). The first voltage may be a voltage for generating a torque to reduce the speed of the electronic apparatus 100 by supplying the current direction of the motor in the opposite direction.

For example, the first voltage may be a preset voltage. The first voltage may be changed according to the user's setting.

For example, the first voltage may be a calculated voltage. The electronic apparatus 100 may calculate the first voltage based on the mass, the speed, and the inclination angle. The greater the mass, the higher the first voltage may be. The faster the speed, the higher the first voltage may be. The greater the inclination angle, the higher the first voltage may be.

After the first voltage is supplied, the electronic apparatus 100 may identify whether the second event has occurred (S720).

The second event may include at least one of an event in which a preset time has elapsed from the time point at which the first voltage is supplied, an event in which the stop torque is less than or equal to the critical torque, or an event in which the speed is less than or equal to a critical speed.

For example, the preset time may be changed according to the user's setting. The electronic apparatus 100 may supply the first voltage at a first time point. When the preset time elapses from the first time point, the electronic apparatus 100 may change the first voltage.

For example, the electronic apparatus 100 may calculate the stop torque in real time. When the stop torque is lower than or equal to the critical torque, the electronic apparatus 100 may change the first voltage.

For example, the electronic apparatus 100 may calculate the speed of the electronic apparatus 100 in real time. When the speed is less than or equal to the critical speed, the electronic apparatus 100 may change the first voltage.

When the second event is identified (S720-Y), the electronic apparatus 100 may supply the second voltage for stopping (S725). The second voltage may be a voltage for generating a torque to reduce the speed of the electronic apparatus 100 by supplying the current direction of the motor in the opposite direction.

The second voltage may be different from the first voltage. For example, the second voltage may be lower than the first voltage. The electronic apparatus 100 may supply the second voltage lower than the first voltage to gradually reduce the speed.

After the second voltage is supplied, the electronic apparatus 100 may identify whether the third event has occurred (S730).

The third event may include at least one of an event in which the electronic apparatus 100 is in the stop state or an event in which the speed is 0 during the first critical time.

For example, the electronic apparatus 100 may confirm whether its current state is the stop state.

For example, the electronic apparatus 100 may confirm whether the speed is 0 for a critical time to confirm whether the current state is in the stop state. The first critical time may be a value for confirming whether the speed is constantly 0. When the speed of the electronic apparatus 100 becomes 0 on an uphill road, the speed may increase when coming down from the uphill road again.

When the third event is identified (S730-Y), the electronic apparatus 100 may supply the third voltage for stopping (S735). The third voltage may be a voltage for generating a torque to reduce the speed of the electronic apparatus 100 by supplying the current direction of the motor in the opposite direction.

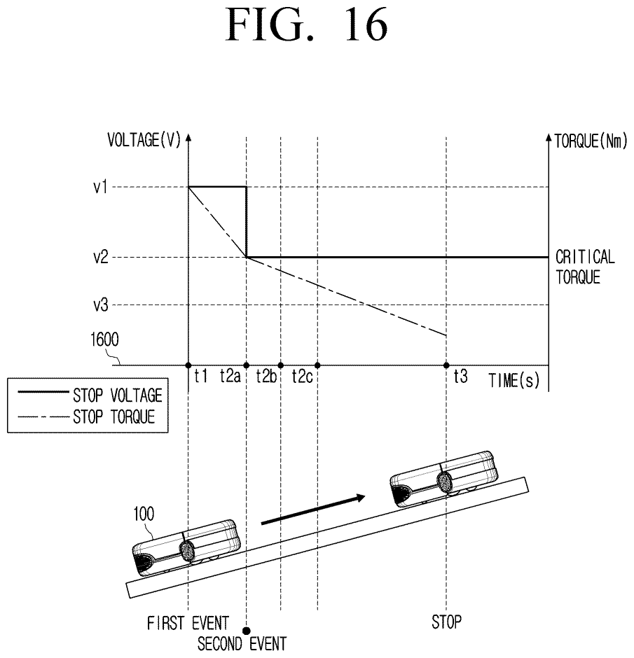

For example, the third voltage may be the same as the second voltage. A description related thereto will be described with reference to FIGS. 16 to 18.

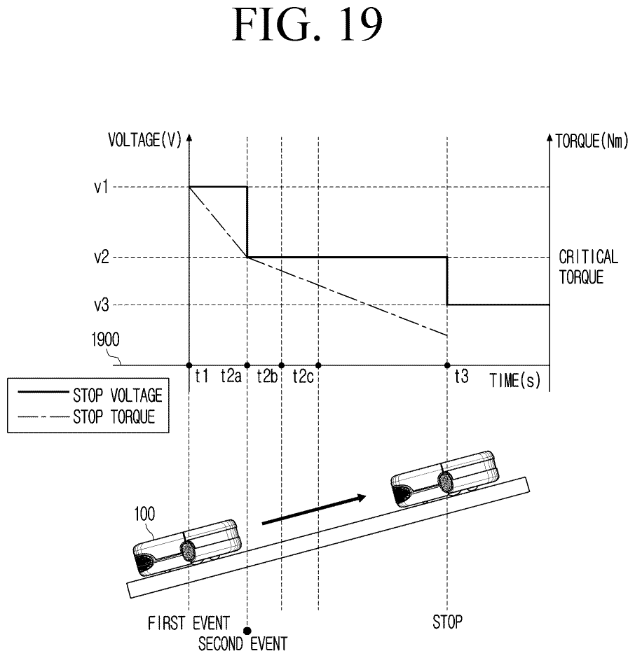

For example, the third voltage may be lower than the second voltage. A description related thereto will be described with reference to FIGS. 19 to 21.

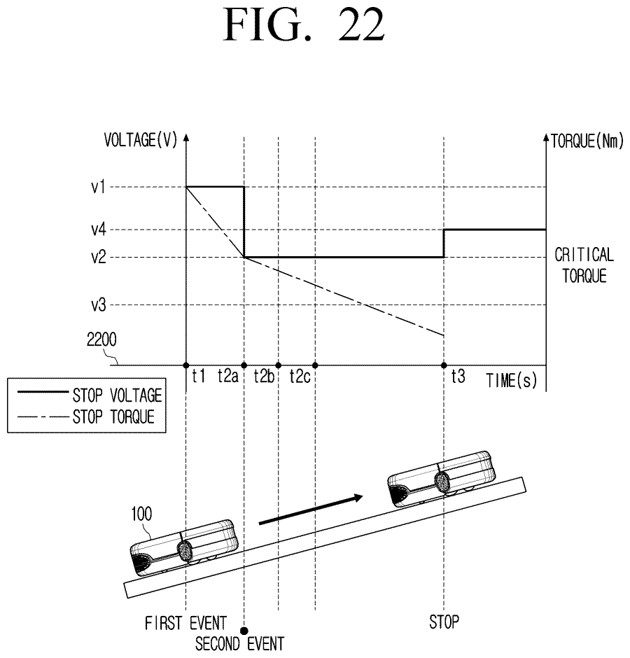

For example, the third voltage may be higher than the second voltage. A description related thereto will be described with reference to FIGS. 22 to 25.

After the third voltage is supplied, the electronic apparatus 100 may identify whether the fourth event has occurred (S740).

The fourth event may include at least one of an event of receiving a power cutoff command or an event in which the stop torque is 0 during the second critical time.

For example, the electronic apparatus 100 may receive a power cutoff command input by a user.

For example, the electronic apparatus 100 may stop supplying power when the second critical time has elapsed from the time point at which it is determined to be in the stop state.

For example, the electronic apparatus 100 may calculate the stop torque in real time. The electronic apparatus 100 may confirm whether the stop torque is 0 during the second critical time. When the stop torque is 0, it may be determined that the current electronic apparatus 100 is on a flat road.

For example, the first critical time and the second critical time may be the same.

For example, the first critical time and the second critical time may be different. The second critical time may be greater than the first critical time. Since the brake function may not be performed when the voltage supply ceases, there is a risk that the electronic apparatus 100 may move on the slope. Therefore, the second critical time may be greater than the first critical time.

When the fourth event is identified (S740-Y), the electronic apparatus 100 may stop supplying the voltage (S745).

For example, the electronic apparatus 100 may control the switch 190 of FIG. 6 to turn off so that the fourth voltage (driving voltage) is not supplied to the motor.

The electronic apparatus 100 may determine that the brake function is not necessary and may stop supplying the power.

For example, the operation of cutting off the voltage may represent an operation in which the electronic apparatus 100 performs a power saving mode.

For example, the operation of cutting off the voltage may represent an operation in which the electronic apparatus 100 completely turns off the power.

The embodiments for each of the first event, the second event, the third event, and the fourth event described in FIG. 7 may be mutually combined. Accordingly, a total of 36 embodiments 1-a-1-a, 1-a-1b, . . . , 3-c-2-b may exist.

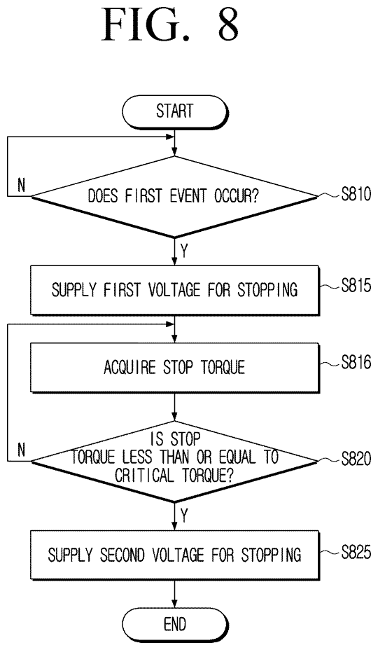

FIG. 8 is a diagram for describing an operation of changing a voltage using stop torque according to an embodiment.

Operations S810, S815, S820, and S825 of FIG. 8 may correspond to the operations S710, S715, S720, and S725 of FIG. 7. Accordingly, for additional implementation details, reference may be made to the descriptions of FIG. 7.

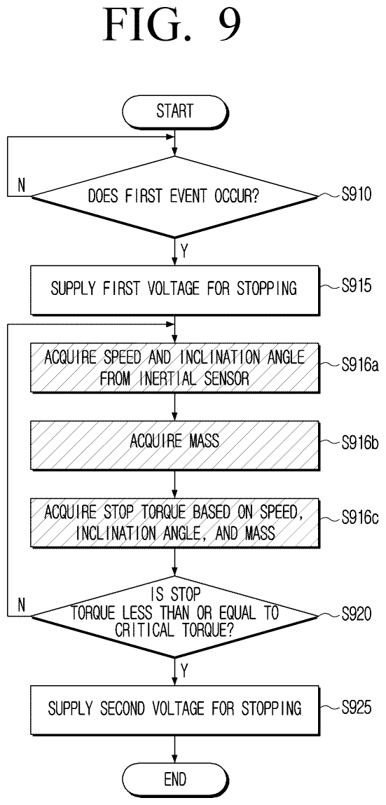

The electronic apparatus 100 may acquire the stop torque after supplying the first voltage (S816). The description related to the stop torque will be described with reference to FIGS. 9 to 13.

The electronic apparatus 100 may identify whether the stop torque is less than or equal to the critical torque (S820).

When the stop torque is less than or equal to the critical torque (S820-Y), the electronic apparatus 100 may supply the second voltage for stopping (S825).

When the stop torque exceeds the critical torque (S820-N), the electronic apparatus 100 may repeat the operations S816 and S820.

FIG. 9 is a diagram for describing the operation of calculating stop torque according to an embodiment.

Operations S910, S915, S920, and S925 of FIG. 9 may correspond to the operations S810, S815, S820, and S825 of FIG. 8.

After supplying the first voltage, the electronic apparatus 100 may calculate the stop torque. The electronic apparatus 100 may acquire at least one of the speed or the inclination angle from the inertial sensor 151 (S916a).

The electronic apparatus 100 may acquire the mass of the electronic apparatus 100 (S916b).

The electronic apparatus 100 may acquire the stop torque based on at least one of the speed, the inclination angle, or the mass (S916c).

The electronic apparatus 100 may store a preset first function that uses at least one of the speed, the inclination angle, or the mass as a parameter. The electronic apparatus 100 may calculate the stop torque based on the preset second function.

When the stop torque is acquired, the electronic apparatus 100 may perform operations S920 and S925.

FIG. 10 is a diagram for describing the operation of calculating stop torque according to an embodiment.

Operations S1010, S1015, S1020, and S1025 of FIG. 10 may correspond to the operations S810, S815, S820, and S825 of FIG. 8.

After supplying the first voltage, the electronic apparatus 100 may calculate the stop torque. The electronic apparatus 100 may acquire at least one of the speed or the inclination angle from the inertial sensor 151 (S1016a).

The electronic apparatus 100 may acquire at least one of the wheel radius, the mass, the gravitational acceleration, and the stop time of the electronic apparatus 100 (S1016b).

The electronic apparatus 100 may acquire the stop torque based on at least one of the speed, the inclination angle, the wheel radius, the mass, the gravitational acceleration, and the stop time (S1016c).

The electronic apparatus 100 may store a preset second function having at least one of speed, the inclination angle, the wheel radius, mass, the gravitational acceleration, and the stop time as a parameter. The electronic apparatus 100 may calculate the stop torque based on the preset second function.

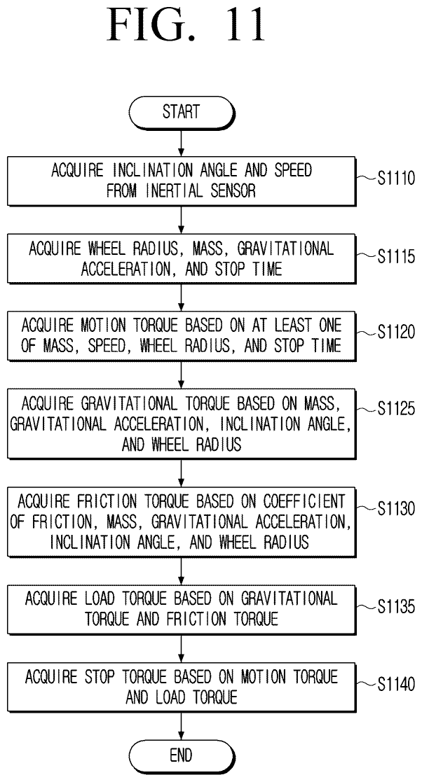

FIG. 11 is a diagram for describing the operation of calculating stop torque according to an embodiment.

Referring to FIG. 11, the electronic apparatus 100 may calculate the stop torque in real time. The electronic apparatus 100 may acquire at least one of the inclination angle or the speed from the inertial sensor 151 (S1110).

The electronic apparatus 100 may acquire at least one of the wheel radius, the mass, the gravitational acceleration, and the stop time (S1115).

The electronic apparatus 100 may acquire the motion torque based on at least one of mass, the speed, the wheel radius, and the stop time (S1120). A description related thereto will be described in an embodiment 1320 of FIG. 13.

The electronic apparatus 100 may acquire gravitational torque based on at least one of mass, the gravitational acceleration, the inclination angle, and the wheel radius (S1125). A description related thereto will be described in an embodiment 1330 of FIG. 13.

The electronic apparatus 100 may acquire friction torque based on the coefficient of friction, mass, the gravitational acceleration, the inclination angle, and the wheel radius (S1130). A description related thereto will be described in an embodiment 1340 of FIG. 13.

The electronic apparatus 100 may acquire the load torque based on the gravitational torque and the friction torque (S1135). As an example, the electronic apparatus 100 may acquire the load torque by adding up the gravitational torque and the friction torque. The electronic apparatus 100 may acquire the stop torque based on the motion torque and the load torque (S1140). A description related thereto will be described in an embodiment 1310 of FIG. 13.

The process of calculating the stop torque described in FIG. 11 may be applied in various situations or operating conditions during the operation of the electronic apparatus 100. For example, the operations of FIG. 11 may be applied in step S816 of FIG. 8. For example, the operations of FIG. 11 may be applied to the operation of determining whether the stop torque is 0 during the second critical time in step S740 of FIG. 7.

FIG. 12 is a diagram for describing the operation of calculating stop torque according to an embodiment.

The electronic apparatus 100 may acquire at least one of the inclination angle or the speed from the inertial sensor 151. The inclination angle may represent the inclination angle based on the electronic apparatus 100. The speed may be the speed of the electronic apparatus 100.

The electronic apparatus 100 may receive at least one of the wheel radius of the electronic apparatus 100, the mass of the electronic apparatus 100, the gravitational acceleration, or the stop time from the memory 110.

The electronic apparatus 100 may acquire the stop torque based on at least one of the inclination angle, the speed, the wheel radius of the electronic apparatus 100, the mass of the electronic apparatus 100, the gravitational acceleration, or the stop time.

Referring to the embodiment 1210 of FIG. 12, the electronic apparatus 100 may acquire the stop torque. The electronic apparatus 100 may acquire the stop torque based on the motion torque, the gravitational torque, and the friction torque. The electronic apparatus 100 may acquire the stop torque by adding up the motion torque and the load torque. The electronic apparatus 100 may acquire the load torque by subtracting the friction torque from the gravitational torque. The electronic apparatus 100 may acquire the first torque by adding up the gravitational torque and the motion torque, and acquire the stop torque by subtracting the friction torque from the first torque.

Referring to the embodiment 1220 of FIG. 12, the electronic apparatus 100 may acquire the motion torque. The electronic apparatus 100 may acquire the motion torque based on the mass, the speed, the wheel radius, and the stop time. The motion torque may be proportional to the radius, the mass, and the speed. The motion torque may be inversely proportional to the stop time.

The stop time may be the time taken from the current time point to stop. The stop time may represent the time to stop at the time point at which the motion torque is calculated.

For example, the stop time may represent a preset time. The stop time may be changed according to the user's setting.

For example, the stop time may be dynamically changed. The stop time may be calculated multiple times. The stop time may be gradually decreased each time it is calculated multiple times. The electronic apparatus 100 may acquire a first stop time based on the time point at which the first motion torque is calculated. The electronic apparatus 100 may acquire a second stop time based on the time point at which the second motion torque is calculated. The second stop time may be lower than the first stop time. The electronic apparatus 100 may gradually decrease the stop time based on the passage of time.

Referring to the embodiment 1230 of FIG. 12, the electronic apparatus 100 may acquire the gravitational torque. The gravitational torque may be acquired based on the mass, the gravitational acceleration, the inclination angle, and the wheel radius. The gravitational torque may be proportional to the mass, the gravitational acceleration, and the wheel radius. The gravitational torque may have a relationship related to the inclination angle and the sine function.

Referring to the embodiment 1340 of FIG. 12, the electronic apparatus 100 may acquire the friction torque. The electronic apparatus 100 may acquire friction torque based on the coefficient of friction, mass, the gravitational acceleration, the inclination angle, and the wheel radius. The friction torque may be a proportional relationship to the coefficient of friction, the mass, the gravitational acceleration, and the wheel radius. The friction torque may have a relationship related to the inclination angle and a cos function.

The coefficient of friction may be calculated in various ways. A description related thereto will be described with reference to FIG. 13.

FIG. 13 is a diagram for describing an operation of calculating a coefficient of friction according to an embodiment.

Referring to the embodiment 1310 of FIG. 13, the coefficient of friction μa may be a constant value. The electronic apparatus 100 may store a preset coefficient of friction μa. The preset coefficient of friction μa may be a value representing an average degree of friction. The coefficient of friction μa may be changed according to a user's setting.

Referring to the embodiment 1320 of FIG. 13, the electronic apparatus 100 may acquire the coefficient of friction μ through the degree of slippage. The electronic apparatus 100 may calculate the degree of slippage by comparing a linear speed vwheel of the wheel with a speed vdevice of the electronic apparatus 100. The electronic apparatus 100 may calculate the degree of slippage based on the linear speed vwheel of the wheel with the speed vdevice of the electronic apparatus 100.

The electronic apparatus 100 may acquire the final coefficient of friction μ by considering the basic coefficient of friction μb and the degree of slippage together. The basic coefficient of friction μb may be a preset value. For example, the basic coefficient of friction μb may be the same as the coefficient of friction μa of the embodiment 1310. For example, the basic coefficient of friction μb may be different from the coefficient of friction μa of the embodiment 1310.

When the linear speed vwheel of the wheel is greater than the speed vdevice of the electronic apparatus 100, the electronic apparatus 100 may determine that the slippage has occurred. The coefficient of friction μ may decrease as the linear speed vwheel of the wheel is faster than the speed vdevice of the electronic apparatus 100.

When the linear speed vwheel of the wheel and the speed vdevice of the electronic apparatus 100 are the same, the electronic apparatus 100 may determine that there is no slippage. The coefficient of friction μ may be the basic coefficient of friction μb.

When the linear speed vwheel of the wheel is lower than the speed vdevice of the electronic apparatus 100, it may be determined that the electronic apparatus 100 is in a braking operating condition. The coefficient of friction μ may increase as the linear speed vwheel of the wheel is slower than the speed vdevice of the electronic apparatus 100.

Referring to the embodiment 1330 of FIG. 13, the electronic apparatus 100 may acquire the coefficient of friction μ through the sensing data.

For example, the electronic apparatus 100 may acquire the sensing data including a captured image through an image sensor. The electronic apparatus 100 may analyze the sensing data to identify an object indicating a material of a floor.

For example, the electronic apparatus 100 may acquire the sensing data including LIDAR data through a LIDAR sensor. The electronic apparatus 100 may analyze the sensing data to identify the object indicating the material of the floor.

The electronic apparatus 100 may store a coefficient of friction table that matches different coefficient of frictions for each object. The electronic apparatus 100 may identify the coefficient of friction μ corresponding to an identified object based on the coefficient of friction table.

For example, when an object o1 is identified, the electronic apparatus 100 may identify the coefficient of friction μ as the coefficient of friction μ1 based on the matching table.

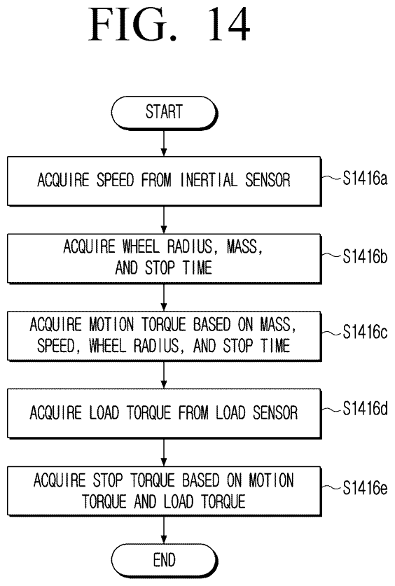

FIG. 14 is a diagram for describing the operation of calculating stop torque according to an embodiment.

Referring to FIG. 14, the electronic apparatus 100 may acquire the speed from the inertial sensor 151. The speed may be the speed of the electronic apparatus 100 (S1416a).

The electronic apparatus 100 may acquire the wheel radius of the electronic apparatus 100, the mass of the electronic apparatus 100, or the stop time (S1416b). The electronic apparatus 100 may acquire the motion torque based on at least one of the mass, the speed, the wheel radius, and the stop time (S1416c).

The electronic apparatus 100 may include a load sensor. The load sensor may sense a load related to the electronic apparatus 100. The load sensor may sense data about the load received by the electronic apparatus 100 based on the mass of the electronic apparatus 100. As an example, the electronic apparatus 100 may acquire the sensing data that may distinguish between a case where the electronic apparatus 100 is on an inclined surface and a case where the electronic apparatus 100 is on a flat road through the load sensor.

The electronic apparatus 100 may acquire the load torque from the load sensor (S1416d). The electronic apparatus 100 may acquire the load torque based on the sensing data received from the load sensor.

The electronic apparatus 100 may acquire the stop torque based on the motion torque and the load torque (S1416e). The electronic apparatus 100 may acquire the stop torque by adding up the load torque and the motion torque.

FIG. 15 is a diagram for describing an operation of controlling a magnitude of voltage using an inclination angle according to an embodiment.

Operations S1520, S1525, S1530, and S1535 of FIG. 15 may correspond to operations S720, S725, S730, and S735 of FIG. 7. Accordingly, for additional implementation details, reference may be made to the descriptions of FIG. 7.

After the second voltage is supplied, the electronic apparatus 100 may acquire the inclination angle and the speed from the inertial sensor 151 (S1526).

The electronic apparatus 100 may identify whether the speed is 0 during the first critical time. The first critical time may be changed according to the user's settings. When the speed is 0 during the first critical time (S1530-Y), the electronic apparatus 100 may identify whether the inclination angle is greater than or equal to the critical angle (S1531). The critical angle may be changed according to the user's setting. When the speed is 0 during the first critical time (S1530-Y), the electronic apparatus 100 may determine that the electronic apparatus 100 is stopped. The electronic apparatus 100 may analyze the inclination angle in the stop state.

When the inclination angle is less than the critical angle (S1531-N), the electronic apparatus 100 may supply the third voltage for stopping (S1535).

When the inclination angle is greater than or equal to the critical angle (S1531-Y), the electronic apparatus 100 may supply the fourth voltage for stopping (S15340).

For example, the fourth voltage may be greater than the third voltage. When the inclination angle is greater than or equal to the critical angle (S1531-Y), the electronic apparatus 100 may determine that the electronic apparatus 100 is located on the inclined surface. When located on the inclined surface, the electronic apparatus 100 may supply a voltage (fourth voltage) for stopping that is higher than the third voltage. In order to prevent slipping on the inclined surface, the electronic apparatus 100 may supply the fourth voltage that is higher than the third voltage.

FIGS. 16 to 24 illustrate embodiments of changing the magnitude of voltage supplied in various situations or operating conditions.

It is assumed that the electronic apparatus 100 is moving at a first time point t1. The moving speed may vary depending on the embodiment. It is assumed that the electronic apparatus 100 identifies the first event (see FIG. 7) for stopping at the first time point t1. The electronic apparatus 100 may supply a first voltage v1 for stopping at the first time point t1. The electronic apparatus 100 may calculate the stop torque from the first time point t1. When the first voltage v1 for stopping is supplied, the speed of the electronic apparatus 100 may be reduced. When the speed of the electronic apparatus 100 is reduced, the stop torque may also be reduced. The electronic apparatus 100 may identify whether the stop torque is less than or equal to the critical torque. When the stop torque is below the critical torque, the electronic apparatus 100 may change the first voltage v1 to the second voltage v2.

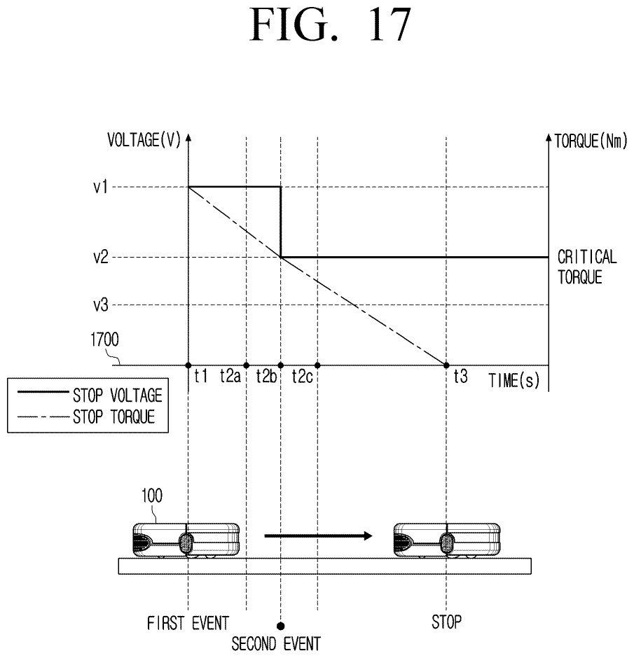

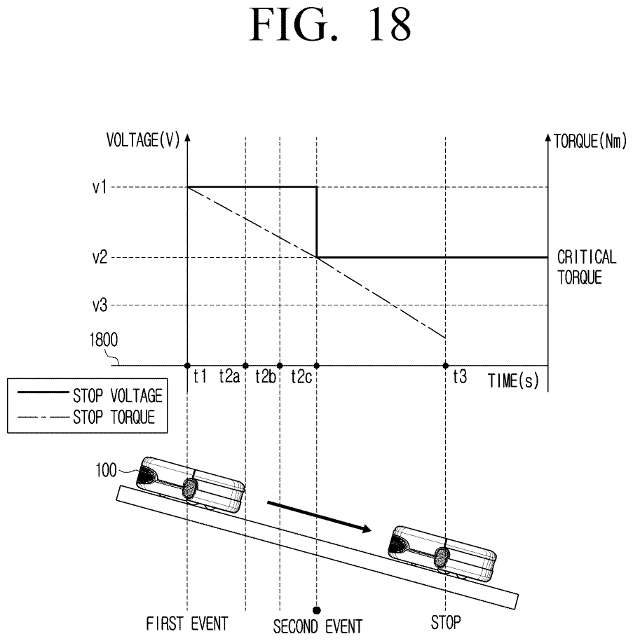

The above situation may be applied to all of FIGS. 16 to 24. Accordingly, for additional implementation details of an embodiment described with respect to one or more of the drawings, reference may be to the descriptions of FIGS. 16 to 24. The embodiments of FIGS. 16 to 24 may be individually applied to the electronic apparatus 100. On an uphill road, one of the embodiments of FIGS. 16, 19, and 22 may be applied. On the flat road, one of the embodiments of FIGS. 17, 20, and 23 may be applied. In the downhill, one of the embodiments of FIGS. 18, 21, and 24 may be applied. Accordingly, a total of 27 embodiments may be applied to the electronic apparatus 100.

FIG. 16 is a diagram for describing an operation of controlling a voltage on an uphill road according to an embodiment.

Referring to an embodiment 1600 of FIG. 16, when the stop torque is less than or equal to the critical torque, the electronic apparatus 100 may identify that the second event has occurred. The electronic apparatus 100 may identify a second time point t2a at which the second event is identified. When the second event is identified, the electronic apparatus 100 may change the supply voltage from the first voltage v1 to the second voltage v2 at the second time point t2a.

The second time point t2a of FIG. 16 may be earlier than a second time point t2b of FIG. 17 and a second time point t2c of FIG. 18. Since gravity acts in the opposite direction of the moving direction on the uphill road, when the same voltage is supplied, the stop torque may decrease faster than on the flat or downhill road.

The electronic apparatus 100 may stop based on the first voltage v1 and the second voltage v2. When it is identified as the stop state, the electronic apparatus 100 may identify that the third event has occurred. The electronic apparatus 100 may identify a third time point t3 at which the third event has occurred.

When the third event is identified, the electronic apparatus 100 may supply the second voltage v2 as it is at the third time point t3. The electronic apparatus 100 may supply the second voltage v2 equally before and after stopping.

Even after stopping, since the gravitational torque acts on the electronic apparatus 100 according to the inclination angle, the stop torque may not be 0.

FIG. 17 is a diagram for describing the operation of controlling a voltage on a flat road according to an embodiment.

Referring to an embodiment 1700 of FIG. 17, when the stop torque is less than or equal to the critical torque, the electronic apparatus 100 may identify that the second event has occurred. The electronic apparatus 100 may identify the second time point t2b at which the second event is identified. When the second event is identified, the electronic apparatus 100 may change the supply voltage from the first voltage v1 to the second voltage v2 at the second time point t2b.

The second time point t2b of FIG. 17 may be later than the second time point t2a of FIG. 16 and earlier than the second time point t2c of FIG. 18. Since the gravitational torque is 0 on the flat road, when the same voltage is supplied, the stop torque may decrease more slowly than on the uphill road and decrease more quickly than on the downhill road.

The electronic apparatus 100 may stop based on the first voltage v1 and the second voltage v2. When it is identified as the stop state, the electronic apparatus 100 may identify that the third event has occurred. The electronic apparatus 100 may identify the third time point t3 at which the third event has occurred.

When the third event is identified, the electronic apparatus 100 may supply the second voltage v2 as it is at the third time point t3. The electronic apparatus 100 may supply the second voltage v2 equally before and after stopping.

Since the inclination angle is 0 after stopping, the gravitational torque may not act on the electronic apparatus 100.

FIG. 18 is a diagram for describing the operation of controlling a voltage on a downhill road according to an embodiment.

Referring to an embodiment 1800 of FIG. 18, when the stop torque is less than or equal to the critical torque, the electronic apparatus 100 may identify that the second event has occurred. The electronic apparatus 100 may identify the second time point t2c at which the second event is identified. When the second event is identified, the electronic apparatus 100 may change the supply voltage from the first voltage v1 to the second voltage v2 at the second time point t2c.

The second time point t2c of FIG. 18 may be later than the second time point t2a of FIG. 16 and the second time point t2b of FIG. 17. Since gravity acts in the direction of movement on the downhill road, when the same voltage is supplied, the stop torque may be reduced more slowly than on the uphill road or on the flat road.

The electronic apparatus 100 may stop based on the first voltage v1 and the second voltage v2. When it is identified as the stop state, the electronic apparatus 100 may identify that the third event has occurred. The electronic apparatus 100 may identify the third time point t3 at which the third event has occurred.

When the third event is identified, the electronic apparatus 100 may supply the second voltage v2 as it is at the third time point t3. The electronic apparatus 100 may supply the second voltage v2 equally before and after stopping.

Even after stopping, since the gravitational torque acts on the electronic apparatus 100 according to the inclination angle, the stop torque may not be 0.

FIG. 19 is a diagram for describing an operation of controlling a voltage on an uphill road according to an embodiment.

Referring to an embodiment 1900 of FIG. 19, when the stop torque is less than or equal to the critical torque, the electronic apparatus 100 may identify that the second event has occurred. The electronic apparatus 100 may identify the second time point t2a at which the second event is identified. When the second event is identified, the electronic apparatus 100 may change the supply voltage from the first voltage v1 to the second voltage v2 at the second time point t2a.

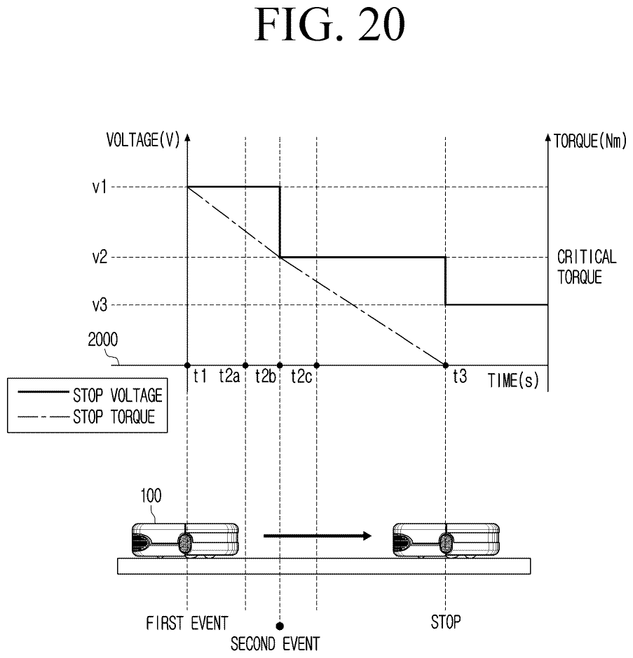

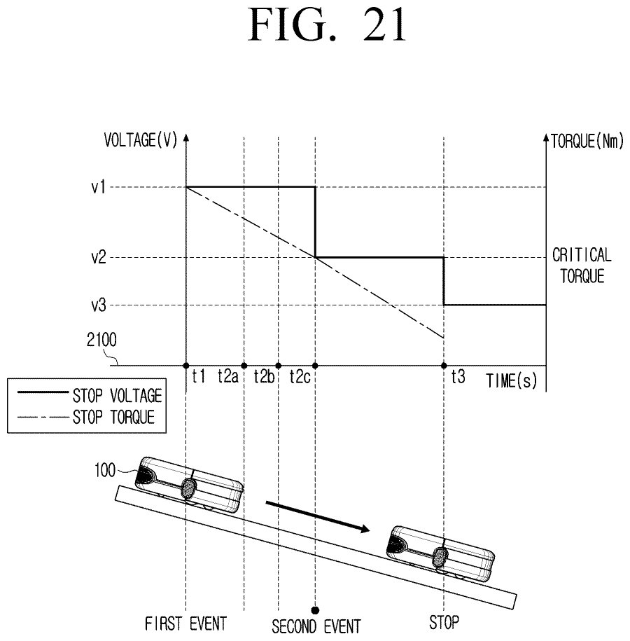

The second time point t2a of FIG. 19 may be earlier than the second time point t2b of FIG. 20 and the second time point t2c of FIG. 21. Since gravity acts in the opposite direction of the moving direction on the uphill road, when the same voltage is supplied, the stop torque may decrease faster than on the flat or downhill road.

The electronic apparatus 100 may stop based on the first voltage v1 and the second voltage v2. When it is identified as the stop state, the electronic apparatus 100 may identify that the third event has occurred. The electronic apparatus 100 may identify the third time point t3 at which the third event has occurred.

When the third event is identified, the electronic apparatus 100 may change the second voltage v2 to a third voltage v3 at the third time point t3. The third voltage v3 may be lower than the second voltage v2. In the case of the stop state, the electronic apparatus 100 may supply the third voltage v3 that is lower than the second voltage v2. When the supply voltage is reduced by determining the stop state, the power consumption may be reduced.

Even after stopping, since the gravitational torque acts on the electronic apparatus 100 according to the inclination angle, the stop torque may not be 0.

FIG. 20 is a diagram for describing the operation of controlling a voltage on a flat road according to an embodiment.

Referring to an embodiment 2000 of FIG. 20, when the stop torque is less than or equal to the critical torque, the electronic apparatus 100 may identify that the second event has occurred. The electronic apparatus 100 may identify the second time point t2b at which the second event is identified. When the second event is identified, the electronic apparatus 100 may change the supply voltage from the first voltage v1 to the second voltage v2 at the second time point t2b.

The second time point t2b of FIG. 20 may be later than the second time point t2a of FIG. 19 and earlier than the second time point t2c of FIG. 21. Since the gravitational torque is 0 on the flat road, when the same voltage is supplied, the stop torque may decrease more slowly than on the uphill road and decrease more quickly than on the downhill road.

The electronic apparatus 100 may stop based on the first voltage v1 and the second voltage v2. When it is identified as the stop state, the electronic apparatus 100 may identify that the third event has occurred. The electronic apparatus 100 may identify the third time point t3 at which the third event has occurred.

When the third event is identified, the electronic apparatus 100 may change the second voltage v2 to the third voltage v3 at the third time point t3. The third voltage v3 may be lower than the second voltage v2. In the case of the stop state, the electronic apparatus 100 may supply the third voltage v3 that is lower than the second voltage v2. When the supply voltage is reduced by determining the stop state, the power consumption may be reduced.

Since the inclination angle is 0 after stopping, the gravitational torque may not act on the electronic apparatus 100.

FIG. 21 is a diagram for describing the operation of controlling a voltage on a downhill road according to an embodiment.

Referring to an embodiment 2100 of FIG. 21, when the stop torque is less than or equal to the critical torque, the electronic apparatus 100 may identify that the second event has occurred. The electronic apparatus 100 may identify the second time point t2c at which the second event is identified. When the second event is identified, the electronic apparatus 100 may change the supply voltage from the first voltage v1 to the second voltage v2 at the second time point t2c.

The second time point t2c of FIG. 21 may be later than the second time point t2a of FIG. 19 and the second time point t2b of FIG. 20. Since gravity acts in the direction of movement on the downhill road, when the same voltage is supplied, the stop torque may be reduced more slowly than on the uphill road or on the flat road.

The electronic apparatus 100 may stop based on the first voltage v1 and the second voltage v2. When it is identified as the stop state, the electronic apparatus 100 may identify that the third event has occurred. The electronic apparatus 100 may identify the third time point t3 at which the third event has occurred.

When the third event is identified, the electronic apparatus 100 may change the second voltage v2 to a third voltage v3 at the third time point t3. The third voltage v3 may be lower than the second voltage v2. In the case of the stop state, the electronic apparatus 100 may supply the third voltage v3 that is lower than the second voltage v2. When the supply voltage is reduced by determining the stop state, the power consumption may be reduced.

Even after stopping, since the gravitational torque acts on the electronic apparatus 100 according to the inclination angle, the stop torque may not be 0.

FIG. 22 is a diagram for describing an operation of controlling a voltage on an uphill road according to an embodiment.

Referring to an embodiment 2200 of FIG. 22, when the stop torque is less than or equal to the critical torque, the electronic apparatus 100 may identify that the second event has occurred. The electronic apparatus 100 may identify the second time point t2a at which the second event is identified. When the second event is identified, the electronic apparatus 100 may change the supply voltage from the first voltage v1 to the second voltage v2 at the second time point t2a.

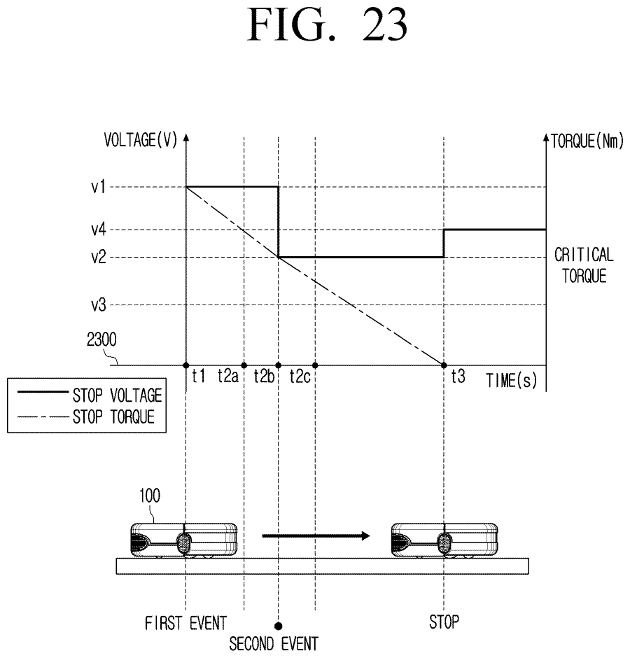

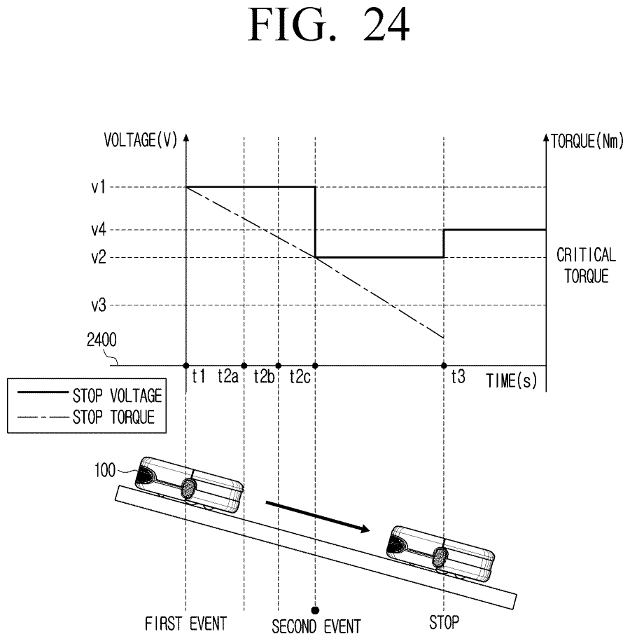

The second time point t2a of FIG. 22 may be earlier than the second time point t2b of FIG. 23 and the second time point t2c of FIG. 24. Since gravity acts in the opposite direction of the moving direction on the uphill road, when the same voltage is supplied, the stop torque may decrease faster than on the flat or downhill road.

The electronic apparatus 100 may stop based on the first voltage v1 and the second voltage v2. When it is identified as the stop state, the electronic apparatus 100 may identify that the third event has occurred. The electronic apparatus 100 may identify the third time point t3 at which the third event has occurred.

When the third event is identified, the electronic apparatus 100 may change the second voltage v2 to a fourth voltage v4 at the third time point t3. The fourth voltage v4 may be higher than the second voltage v2. In the case of the stop state, the electronic apparatus 100 may supply the fourth voltage v4 that is higher than the second voltage v2. Even after stopping, the supply voltage may be increased to prevent the electronic apparatus 100 from moving on the inclined surface.

Even after stopping, since the gravitational torque acts on the electronic apparatus 100 according to the inclination angle, the stop torque may not be 0.

FIG. 23 is a diagram for describing the operation of controlling a voltage on a flat road according to an embodiment.

Referring to an embodiment 2300 of FIG. 23, when the stop torque is less than or equal to the critical torque, the electronic apparatus 100 may identify that the second event has occurred. The electronic apparatus 100 may identify the second time point t2b at which the second event is identified. When the second event is identified, the electronic apparatus 100 may change the supply voltage from the first voltage v1 to the second voltage v2 at the second time point t2b.

The second time point t2b of FIG. 23 may be later than the second time point t2a of FIG. 22 and earlier than the second time point t2c of FIG. 24. Since the gravitational torque is 0 on the flat road, when the same voltage is supplied, the stop torque may decrease more slowly than on the uphill road and more quickly than on the downhill road.

The electronic apparatus 100 may stop based on the first voltage v1 and the second voltage v2. When it is identified as the stop state, the electronic apparatus 100 may identify that the third event has occurred. The electronic apparatus 100 may identify the third time point t3 at which the third event has occurred.

When the third event is identified, the electronic apparatus 100 may change the second voltage v2 to the fourth voltage v4 at the third time point t3. The fourth voltage v4 may be higher than the second voltage v2. In the case of the stop state, the electronic apparatus 100 may supply the fourth voltage v4 that is higher than the second voltage v2. Even after stopping, the supply voltage may be increased to prevent the electronic apparatus 100 from moving on the inclined surface.

Since the inclination angle is 0 after stopping, the gravitational torque may not act on the electronic apparatus 100.

FIG. 24 is a diagram for describing the operation of controlling a voltage on a downhill road according to an embodiment.

Referring to an embodiment 2400 of FIG. 24, when the stop torque is less than or equal to the critical torque, the electronic apparatus 100 may identify that the second event has occurred. The electronic apparatus 100 may identify the second time point t2c at which the second event is identified. When the second event is identified, the electronic apparatus 100 may change the supply voltage from the first voltage v1 to the second voltage v2 at the second time point t2c.

The second time point t2c of FIG. 24 may be later than the second time point t2a of FIG. 22 and the second time point t2b of FIG. 23. Since gravity acts in the direction of movement on the downhill road, when the same voltage is supplied, the stop torque may be reduced more slowly than on the uphill road or on the flat road.

The electronic apparatus 100 may stop based on the first voltage v1 and the second voltage v2. When it is identified as the stop state, the electronic apparatus 100 may identify that the third event has occurred. The electronic apparatus 100 may identify the third time point t3 at which the third event has occurred.

When the third event is identified, the electronic apparatus 100 may change the second voltage v2 to the fourth voltage v4 at the third time point t3. The fourth voltage v4 may be higher than the second voltage v2. In the case of the stop state, the electronic apparatus 100 may supply the fourth voltage v4 that is higher than the second voltage v2. Even after stopping, the supply voltage may be increased to prevent the electronic apparatus 100 from moving on the inclined surface.

Even after stopping, since the gravitational torque acts on the electronic apparatus 100 according to the inclination angle, the stop torque may not be 0.

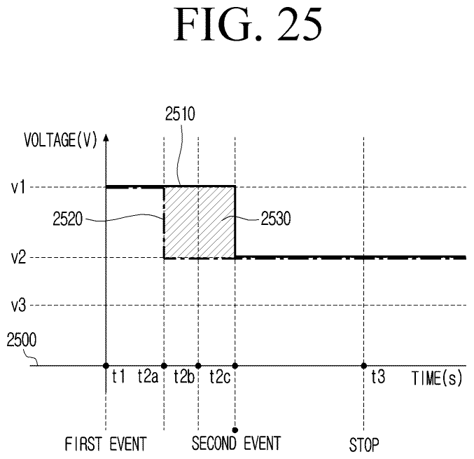

FIG. 25 is a diagram for describing power efficiency according to an embodiment.

Referring to an embodiment 2500 of FIG. 25, a voltage change operating condition for a first embodiment 2510 and a second embodiment 2520 on the uphill road may be illustrated.

According to the first embodiment 2510, the electronic apparatus 100 may change (or maintain) the voltage based on the same criteria without considering the stop torque.

The electronic apparatus 100 may determine the magnitude of the stop voltage and the stop time based on an operating condition of the electronic apparatus 100. The operating condition may be related to the moving speed of the electronic apparatus 100 or the inclination angle of the surface on which the electronic apparatus 100 is traveling.

In three situations, such as the uphill road, the flat road, and the downhill road, the electronic apparatus 100 may determine the supply voltage by considering the operating condition on the downhill road where the stop torque is most (or for the longest) required. According to the first embodiment 2510, the electronic apparatus 100 may change the first voltage v1 to the second voltage v2 at the second time point t2c even in the uphill road operating condition.

According to the second embodiment 2520, the electronic apparatus 100 may determine the voltage change time by considering the stop torque. The second embodiment 2520 may represent the supply voltage of the electronic apparatus 100 on the uphill road.

The power consumption according to the second embodiment 2520 may be saved by an area 2530 compared to the power consumption according to the first embodiment 2510.

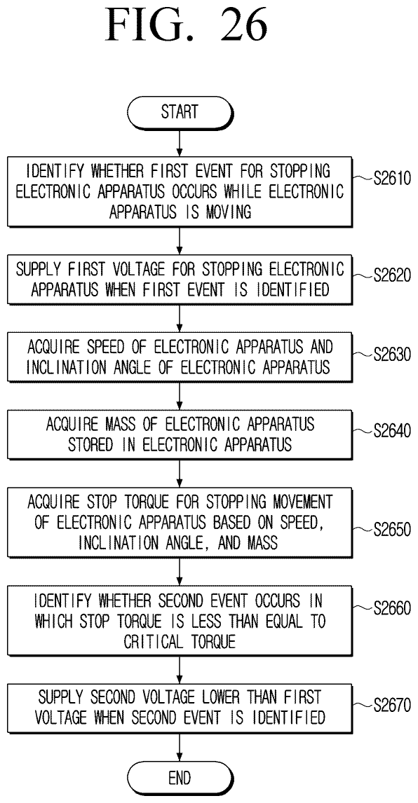

FIG. 26 is a diagram for describing a controlling method of an electronic apparatus 100 according to an embodiment.

Referring to FIG. 26, the controlling method of an electronic apparatus 100 may include identifying whether the first event for stopping the electronic apparatus 100 occurs while the electronic apparatus 100 is moving (S2610), supplying the first voltage for stopping the electronic apparatus 100 when the first event is identified (S2620), acquiring the speed of the electronic apparatus 100 and the inclination angle of the electronic apparatus 100 (S2630), acquiring the mass of the electronic apparatus 100 from data stored in the memory 110 of the electronic apparatus 100 (S2640), acquiring the stop torque for stopping the movement of the electronic apparatus 100 based on the speed, the inclination angle, and the mass (S2650), identifying whether the second event in which the stop torque is less than or equal to the critical torque occurs (S2660), and supplying the second voltage lower than the first voltage when the second event is identified (S2670).

The acquiring of the speed and the inclination angle may be to acquire the speed related to the movement of the electronic apparatus 100 and the inclination angle of the floor on which the electronic apparatus 100 travels based on the sensing data received from the inertial sensor 151.

The first voltage and the second voltage may be voltages supplied to the motor to stop the electronic apparatus 100 by changing the current direction of the motor included in the electronic apparatus 100 to the opposite direction.

In the acquiring of the stop torque, the wheel radius, the gravitational acceleration, and the stop time of the electronic apparatus 100 from data stored in the memory 110 of the electronic apparatus 100 may be acquired, and the stop torque may be acquired based on at least one of the speed, the inclination angle, the mass, the wheel radius, the gravitational acceleration, or the stop time.

In the acquiring of the stop torque, the motion torque may be acquired based on at least one of the mass, the speed, the wheel radius, or the stop time, the load torque related to the gravity and the frictional force acting on the electronic apparatus 100 may be acquired, and the stop torque may be acquired based on the motion torque and the load torque.

In the acquiring of the stop torque, the gravitational torque related to the gravity based on at least one of the mass, the gravitational acceleration, the inclination angle, or the wheel radius may be acquired, the friction torque related to the frictional force based on at least one of the coefficient of friction, the mass, the gravitational acceleration, the inclination angle, or the wheel radius may be acquired, and the load torque may be acquired based on the gravitational torque and the friction torque.

In the acquiring of the stop torque, the linear speed of the wheel of the electronic apparatus 100 may be acquired, and the coefficient of friction based on the speed of the electronic apparatus 100 and the linear speed of the wheel may be acquired.

The controlling method may include causing the electronic apparatus 100 to identify whether the third event in which the electronic apparatus is in the stop state occurs after supplying the second voltage, acquiring the inclination angle at the time point at which the third event is identified, when the third event is identified, and supplying the third voltage smaller than the second voltage when the inclination angle is less than the critical angle.

The controlling method may include supplying the fourth voltage higher than the second voltage when the inclination angle is greater than or equal to the critical angle.

The controlling method may further include identifying whether the fourth event for power cutoff occurs and, cutting off the supply of the third voltage or the fourth voltage when the fourth event is identified.

The above-described methods according to various embodiments of the present disclosure may be implemented in a form of application that may be installed in the existing electronic apparatus.

The above-described methods according to various embodiments of the present disclosure may be implemented only by software upgrade or hardware upgrade of the existing electronic apparatus.

Various embodiments of the disclosure described above may also be performed through an embedded server included in the electronic apparatus or an external server of at least one of the electronic apparatus or the display device.

According to an embodiment of the disclosure, various embodiments described above may be implemented by software including instructions stored in a machine-readable storage medium (for example, a computer-readable storage medium). A machine is a device capable of calling a stored instruction from a storage medium and operating according to the called instruction, and may include the electronic apparatus of the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

According to an embodiment of the disclosure, the above-described methods according to the diverse embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store. In case of the online distribution, at least a portion of the computer program product may be at least temporarily stored in a storage medium such as a memory of a server of a manufacturer, a server of an application store, or a relay server or be temporarily generated.

Each of components (for example, modules or programs) according to various embodiments described above may include a single entity or a plurality of entities, and other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order, or other operations may be added.

Although embodiments of the disclosure have been illustrated and described hereinabove, the disclosure is not limited to the above-described specific embodiments, but may be variously modified by those skilled in the art to which the disclosure pertains without departing from the scope of the disclosure as disclosed in the accompanying claims. These modifications should also be understood to fall within the spirit of the disclosure.

What is claimed is:

1. An electronic apparatus, comprising:
at least one sensor;
memory storing instructions; and
at least one processor,
wherein the instructions, when executed by the at least one processor, individually or collectively, cause the electronic apparatus to:
identify, based on the electronic apparatus moving, whether a first event for stopping the electronic apparatus occurs,
supply a first voltage for stopping the electronic apparatus based on the first event being identified,
acquire, through the at least one sensor, a speed related to movement of the electronic apparatus and an inclination angle of a floor on which the electronic apparatus travels,
acquire, from data stored in the memory, a mass of the electronic apparatus,
acquire a stop torque for a stopping movement of the electronic apparatus based on the speed, the inclination angle, and the mass,
identify whether a second event occurs in which the stop torque is less than or equal to a critical torque, and
supply a second voltage lower than the first voltage based on the second event being identified.

2. The electronic apparatus as claimed in claim 1, wherein the at least one sensor comprises an inertial sensor, and
wherein the instructions, when executed by the at least one processor, individually or collectively, cause the electronic apparatus to:
acquire the speed and the inclination angle based on sensing data received from the inertial sensor.

3. The electronic apparatus as claimed in claim 1, further comprising:
a motor, and
wherein the first voltage and the second voltage are supplied to the motor to stop the electronic apparatus by changing a current direction of the motor to an opposite direction.

4. The electronic apparatus as claimed in claim 1, wherein the instructions, when executed by the at least one processor, individually or collectively, cause the electronic apparatus to:
acquire, from data stored in the memory, a wheel radius, gravitational acceleration, and a stop time of the electronic apparatus, and
acquire the stop torque based on at least one of the speed, the inclination angle, the mass, the wheel radius, the gravitational acceleration, or the stop time.

5. The electronic apparatus as claimed in claim 4, wherein the instructions, when executed by the at least one processor, individually or collectively, cause the electronic apparatus to:
acquire a motion torque based on at least one of the mass, the speed, the wheel radius, or the stop time,
acquire a load torque related to gravity and frictional force acting on the electronic apparatus, and
acquire the stop torque based on the motion torque and the load torque.

6. The electronic apparatus as claimed in claim 5, wherein the instructions, when executed by the at least one processor, individually or collectively, cause the electronic apparatus to:
acquire a gravitational torque related to the gravity based on at least one of the mass, the gravitational acceleration, the inclination angle, or the wheel radius,
acquire a friction torque related to the frictional force based on at least one of a coefficient of friction, the mass, the gravitational acceleration, the inclination angle, or the wheel radius, and
acquire the load torque based on the gravitational torque and the friction torque.

7. The electronic apparatus as claimed in claim 6, wherein the instructions, when executed by the at least one processor, individually or collectively, cause the electronic apparatus to:
acquire a linear speed of a wheel of the electronic apparatus, and
acquire the coefficient of friction based on the speed related to the movement of the electronic apparatus and the linear speed of the wheel.

8. The electronic apparatus as claimed in claim 1, wherein the instructions, when executed by the at least one processor, individually or collectively, cause the electronic apparatus to:
identify, based on the second voltage being supplied, whether a third event occurs in which the electronic apparatus is in a stop state,
acquire the inclination angle through the at least one sensor at a time point at which the third event is identified, and
supply a third voltage less than the second voltage based on the inclination angle being less than a critical angle.

9. The electronic apparatus as claimed in claim 8, wherein the instructions, when executed by the at least one processor, individually or collectively, cause the electronic apparatus to:
supply a fourth voltage higher than the second voltage based on the inclination angle being greater than or equal to the critical angle.

10. The electronic apparatus as claimed in claim 9, wherein the instructions, when executed by the at least one processor, individually or collectively, cause the electronic apparatus to:
identify whether a fourth event for power cutoff occurs, and
stop supplying the third voltage or the fourth voltage based on the fourth event being identified.

11. A controlling method of an electronic apparatus, comprising:
identifying, based on the electronic apparatus moving, whether a first event for stopping the electronic apparatus occurs;
supplying a first voltage for stopping the electronic apparatus based on the first event being identified;
acquiring, through at least one sensor of the electronic apparatus, a speed related to movement of the electronic apparatus and an inclination angle of a floor on which the electronic apparatus travels;
acquiring, from data stored in memory of the electronic apparatus, a mass of the electronic apparatus;
acquiring a stop torque for stopping movement of the electronic apparatus based on the speed, the inclination angle, and the mass;
identifying whether a second event occurs in which the stop torque is less than or equal to a critical torque; and
supplying a second voltage lower than the first voltage based on the second event being identified.

12. The controlling method as claimed in claim 11, wherein, the acquiring of the speed and the inclination angle comprises:
acquiring the speed and the inclination angle based on sensing data received from an inertial sensor of the electronic apparatus.

13. The controlling method as claimed in claim 11, wherein the first voltage and the second voltage are supplied to a motor of the electronic apparatus to stop the electronic apparatus by changing a current direction of the motor to an opposite direction.

14. The controlling method as claimed in claim 11, wherein the acquiring the stop torque comprises:
acquiring, from data stored in the memory of the electronic apparatus, a wheel radius, gravitational acceleration, and a stop time of the electronic apparatus; and
acquiring the stop torque based on at least one of the speed, the inclination angle, the mass, the wheel radius, the gravitational acceleration, or the stop time.

15. The controlling method as claimed in claim 14, wherein the acquiring the stop torque comprises:
acquiring a motion torque based on at least one of the mass, the speed, the wheel radius, or the stop time;
acquiring a load torque related to gravity and frictional force acting on the electronic apparatus; and
acquiring the stop torque based on the motion torque and the load torque.

16. The controlling method as claimed in claim 15, wherein the acquiring the load torque comprises:
acquiring a gravitational torque related to the gravity based on at least one of the mass, the gravitational acceleration, the inclination angle, or the wheel radius;
acquiring a friction torque related to the frictional force based on at least one of a coefficient of friction, the mass, the gravitational acceleration, the inclination angle, or the wheel radius; and
acquiring the load torque based on the gravitational torque and the friction torque.

17. The controlling method as claimed in claim 16, wherein the friction torque is based on the coefficient of friction, and
wherein the acquiring the friction torque comprises:
acquiring a linear speed of a wheel of the electronic apparatus; and
acquiring the coefficient of friction based on the speed related to the movement of the electronic apparatus and the linear speed of the wheel.

18. The controlling method as claimed in claim 11, further comprising:
identifying, based on the second voltage being supplied, whether a third event occurs in which the electronic apparatus is in a stop state;
acquiring the inclination angle through the at least one sensor at a time point at which the third event is identified; and
supplying a third voltage less than the second voltage based on the inclination angle being less than a critical angle.

19. The controlling method as claimed in claim 18, further comprising supplying a fourth voltage higher than the second voltage based on the inclination angle being greater the or equal to the critical angle.

20. A non-transitory computer-readable recording medium having at least one instruction recorded thereon, that, when executed by at least one processor, individually or collectively, cause the at least one processor to:
identify, based on an electronic apparatus moving, whether a first event for stopping the electronic apparatus occurs;
supply a first voltage for stopping the electronic apparatus based on the first event being identified;
acquire, through at least one sensor, a speed related to movement of the electronic apparatus and an inclination angle of a floor on which the electronic apparatus travels,
acquire, from data stored in memory, a mass of the electronic apparatus,
acquire a stop torque for a stopping movement of the electronic apparatus based on the speed, the inclination angle, and the mass;
identify whether a second event occurs in which the stop torque is less than or equal to a critical torque; and
supply a second voltage lower than the first voltage based on the second event being identified.
